(19) United States
(12) Patent Application Publication
(10) Pub. No.: US 2025/0085509 A1
(43) Pub. Date: Mar. 13, 2025

(54) OPTICAL SYSTEM, OPTICAL APPARATUS, AND METHOD FOR MANUFACTURING OPTICAL SYSTEM

(71) Applicant: NIKON CORPORATION, Tokyo (JP)

(72) Inventor: Takamichi KURASHIGE, Tokyo (JP)

(21) Appl. No.: 18/889,330

(22) Filed: Sep. 18, 2024

Related U.S. Application Data
(63) Continuation of application No. PCT/JP2023/012224, filed on Mar. 27, 2023.

(30) Foreign Application Priority Data
Apr. 4, 2022 (JP) 2022-062480

(51) Int. Cl. G02B 9/60; G02B 9/62

(52) U.S. Cl. CPC G02B 9/60; G02B 9/62

(57) ABSTRACT

An optical system including, in order from an object side, a first negative lens having negative refractive power, a second negative lens having negative refractive power, and a rear group is configured so as to satisfy the following conditional expressions:

$$\begin{matrix}5.6 < TL / f < 13.00 \\ 0.3 < f 1 / f 2 < 2. \\ 1.66 < Nave 12 < 2.20 \\ 80. < 2 ω\end{matrix}$$

where TL is the total length of the optical system; f, f1, and f2 are the focal lengths of the optical system, the first negative lens, and the second negative lens, respectively; Nave12 is an average of the refractive indices of the first and second negative lenses; and 2ω is the total field angle of the optical system.

### CROSS-REFERENCE TO RELATED APPLICATIONS

This application is a continuation of International Patent Application No. PCT/JP2023/012224 filed Mar. 27, 2023, which claims priority from Japanese Patent Application No. 2022-062480 filed Apr. 4, 2022, which are incorporated herein by reference.

### FIELD

The present disclosure relates to an optical system, an optical apparatus, and a method for manufacturing an optical system.

### BACKGROUND

A proposed optical system is usable for an optical apparatus that detects the distance to an object, based on the time from when the object is irradiated with light of a predetermined wavelength from a light source until light reflected by the object is received (see, e.g., Japanese Unexamined Patent Publication No. 4-261510).

### SUMMARY

An optical system of the present disclosure includes, in order from an object side, a first negative lens having negative refractive power, a second negative lens having negative refractive power, and a rear group, and satisfies the following conditional expressions.

$$5.6 < TL / f < 13. \\ 0.3 < f 1 / f 2 < 2. \\ 1.66 < Nave 12 < 2.2 \\ 80. < 2 ω$$

where
TL: the total length of the optical system
f: the focal length of the optical system
f1: the focal length of the first negative lens
f2: the focal length of the second negative lens
Nave12: an average of the refractive indices of the first and second negative lenses
2ω: the total field angle of the optical system

An optical system of the present disclosure includes, in order from an object side, a first negative lens having negative refractive power, a second negative lens having negative refractive power, and a rear group, and satisfies the following conditional expressions.

$$0.41 < T 112 / f < 3.95 \\ 0.3 < ( r 31 + r 22 ) / ( r 31 - r 22 ) < 2.6 \\ 80. < 2 ω$$

where
T112: the total thickness on the optical axis from an object-side lens surface of the first negative lens to an image-plane-side lens surface of the second negative lens
f: the focal length of the optical system
r22: the radius of curvature of the image-plane-side lens surface of the second negative lens
r31: the radius of curvature of an object-side lens surface of a lens disposed next to the second negative lens on the image plane side 2ω: the total field angle of the optical system

An optical system of the present disclosure includes, in order from an object side, a first negative lens having negative refractive power, a second negative lens having negative refractive power, and a rear group, and satisfies the following conditional expressions.

$$1.2 < ( - f 1 ) / f < 5.1 \\ 1.91 < ( - f 2 ) / f < 7. \\ 0.9 < T 112 / f < 8. \\ 80. < 2 ω$$

where
f1: the focal length of the first negative lens
f: the focal length of the optical system
f2: the focal length of the second negative lens

T112: the total thickness on the optical axis from an object-side lens surface of the first negative lens to an image-plane-side lens surface of the second negative lens
2ω: the total field angle of the optical system

A method for manufacturing an optical system of the present disclosure is a method for manufacturing an optical system including, in order from an object side, a first negative lens having negative refractive power, a second negative lens having negative refractive power, and a rear group. The method includes disposing lenses so as to satisfy the following conditional expressions.

$$5.6 < TL / f < 13. \\ 0.3 < f 1 / f 2 < 2. \\ 1.66 < Nave 12 < 2.2 \\ 80. < 2 ω$$

where
TL: the total length of the optical system
f: the focal length of the optical system
f1: the focal length of the first negative lens
f2: the focal length of the second negative lens
Nave12: an average of the refractive indices of the first and second negative lenses
2ω: the total field angle of the optical system

### BRIEF DESCRIPTION OF DRAWINGS

FIG. 1 is a cross-sectional view of an optical system of a first example focusing on an object at infinity.

FIG. 2 shows aberrations of the optical system of the first example at d-line.

FIG. 3 is a cross-sectional view of an optical system of a second example focusing on an object at infinity.

FIG. 4 shows aberrations of the optical system of the second example at d-line.

FIG. 5 is a cross-sectional view of an optical system of a third example focusing on an object at infinity.

FIG. 6 shows aberrations of the optical system of the third example at d-line.

FIG. 7 is a cross-sectional view of an optical system of a fourth example focusing on an object at infinity.

FIG. 8 shows aberrations of the optical system of the fourth example at d-line.

FIG. 9 is a cross-sectional view of an optical system of a fifth example focusing on an object at infinity.

FIG. 10 shows aberrations of the optical system of the fifth example at d-line.

FIG. 11 is a cross-sectional view of an optical system of a sixth example focusing on an object at infinity.

FIG. 12 shows aberrations of the optical system of the sixth example at d-line.

FIG. 13 is a cross-sectional view of an optical system of a seventh example focusing on an object at infinity.

FIG. 14 shows aberrations of the optical system of the seventh example at d-line.

FIG. 15 schematically shows an optical apparatus including an optical system of the embodiment.

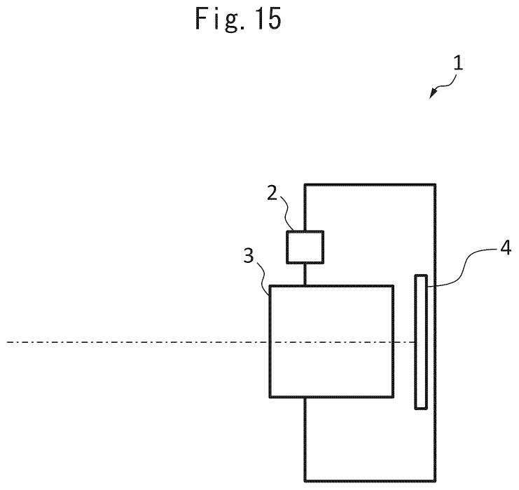

FIG. 16 shows aberrations of the optical system of the first example at s-line.

FIG. 17 is a flowchart outlining a method for manufacturing an optical system of the embodiment.

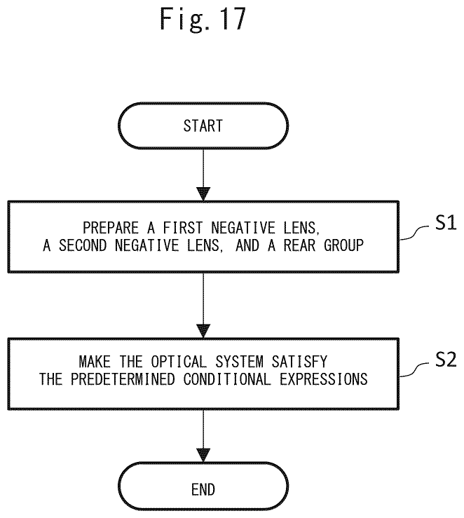

### DESCRIPTION OF EMBODIMENTS

The following describes an optical system, an optical apparatus, and a method for manufacturing an optical system of an embodiment of the present application.

An optical system of the present embodiment includes, in order from an object side, a first negative lens having negative refractive power, a second negative lens having negative refractive power, and a rear group, and satisfies the following conditional expressions.

$$( 1 ) 5.6 < TL / f < 13. \\ ( 2 ) 0.3 < f 1 / f 2 < 2. \\ ( 3 ) 1.66 < Nave 12 < 2.2 \\ ( 4 ) 80. < 2 ω$$

where
TL: the total length of the optical system
f: the focal length of the optical system
f1: the focal length of the first negative lens
f2: the focal length of the second negative lens
Nave12: an average of the refractive indices of the first and second negative lenses
2ω: the total field angle of the optical system

The optical system of the present embodiment is configured so as to have favorable optical performance for light of a predetermined wavelength, such as d-line (wavelength 587.6 nm) and s-line (wavelength 852.1 nm).

The optical system of the present embodiment can be increased in total field angle by the first and second negative lenses.

Conditional expression (1) restricts the ratio of the total length of the optical system to the focal length of the optical system. The total length, of an optical system refers to the distance on the optical axis from a lens surface closest to the object side in the optical system focusing on an object at infinity to the image plane. The optical system of the present embodiment, which satisfies conditional expression (1), can avoid having a long total length and correct aberrations, such as curvature of field, astigmatism, coma aberration, and distortion, appropriately.

If the value of conditional expression (1) is greater than the upper limit in the optical system of the present embodiment, the total length of the optical system will be too long. Further, it will be difficult to correct aberrations, such as curvature of field, astigmatism, and coma aberration.

In the optical system of the present embodiment, the effect of the present embodiment can be ensured by setting the upper limit of conditional expression (1) to 13.00. To further ensure the effect of the present embodiment, the upper limit of conditional expression (1) is preferably set to 12.10 or 11.50, more preferably to 11.10.

If the value of conditional expression (1) is less than the lower limit in the optical system of the present embodiment, it will be difficult to correct aberrations, such as distortion, curvature of field, and astigmatism.

In the optical system of the present embodiment, the effect of the present embodiment can be ensured by setting the lower limit of conditional expression (1) to 5.60. To further ensure the effect of the present embodiment, the lower limit of conditional expression (1) is preferably set to 6.90 or 7.80, more preferably to 8.30.

Conditional expression (2) restricts the ratio between the focal lengths of the first and second negative lenses. The optical system of the present embodiment, which satisfies conditional expression (2), can avoid the lens disposed closest to the object side having a large diameter and correct aberrations, such as curvature of field and astigmatism, appropriately.

If the value of conditional expression (2) is greater than the upper limit in the optical system of the present embodiment, the diameter of the lens disposed closest to the object side will be too large. Further, it will be difficult to correct aberrations, such as curvature of field and astigmatism.

In the optical system of the present embodiment, the effect of the present embodiment can be ensured by setting the upper limit of conditional expression (2) to 2.00. To further ensure the effect of the present embodiment, the upper limit of conditional expression (2) is preferably set to 1.67 or 1.42, more preferably to 1.29.

If the value of conditional expression (2) is less than the lower limit in the optical system of the present embodiment, it will be difficult to correct aberrations, such as curvature of field and astigmatism.

In the optical system of the present embodiment, the effect of the present embodiment can be ensured by setting the lower limit of conditional expression (2) to 0.30. To further ensure the effect of the present embodiment, the lower limit of conditional expression (2) is preferably set to 0.40 or 0.48, more preferably to 0.52.

Conditional expression (3) restricts an average of the refractive indices of the first and second negative lenses at d-line. The optical system of the present embodiment, which satisfies conditional expression (3), can correct the curvature of field appropriately.

If the value of conditional expression (3) is greater than the upper limit in the optical system of the present embodiment, combined negative refractive power of the first and second negative lenses will be too strong, making it difficult to correct curvature of field.

In the optical system of the present embodiment, the effect of the present embodiment can be ensured by setting the upper limit of conditional expression (3) to 2.20. To further ensure the effect of the present embodiment, the upper limit of conditional expression (3) is preferably set to 2.10, more preferably to 2.00.

If the value of conditional expression (3) is less than the lower limit in the optical system of the present embodiment, combined negative refractive power of the first and second negative lenses will be too weak, making it difficult to correct curvature of field.

In the optical system of the present embodiment, the effect of the present embodiment can be ensured by setting the lower limit of conditional expression (3) to 1.66. To further ensure the effect of the present embodiment, the lower limit of conditional expression (3) is preferably set to 1.72, 1.78, or 1.82, more preferably to 1.90.

Conditional expression (4) restricts the total field angle of the optical system. The optical system of the present embodiment, which satisfies conditional expression, can be a wide-angle lens with a large field angle.

An optical system satisfying conditional expressions (1), (2), (3), and (4) is a wide-angle lens, and can avoid having a long total length, avoid the lens disposed closest to the object side having a large diameter, and correct aberrations, such as curvature of field, astigmatism, coma aberration, and distortion, appropriately.

An optical system of the present embodiment includes, in order from an object side, a first negative lens having negative refractive power, a second negative lens having negative refractive power, and a rear group, and satisfies the following conditional expressions.

$$( 5 ) 0.41 < T 112 / f < 3.95 \\ ( 6 ) 0.3 < ( r 31 + r 22 ) / ( r 31 - r 22 ) < 2.6 \\ ( 4 ) 80. < 2 ω$$

where
T112: the total thickness on the optical axis from an object-side lens surface of the first negative lens to an image-plane-side lens surface of the second negative lens
f: the focal length of the optical system
r22: the radius of curvature of the image-plane-side lens surface of the second negative lens
r31: the radius of curvature of an object-side lens surface of a lens disposed next to the second negative lens on the image plane side
2ω: the total field angle of the optical system

Conditional expression (5) restricts the ratio of the total thickness on the optical axis from an object-side lens surface of the first negative lens to an image-plane-side lens surface of the second negative lens to the focal length of the whole optical system. The optical system of the present embodiment, which satisfies conditional expression (5), can avoid having a long total length and correct aberrations, such as curvature of field, astigmatism, coma aberration, and distortion, appropriately.

If the value of conditional expression (5) is greater than the upper limit in the optical system of the present embodiment, the total length of the optical system will be too long, making it difficult to correct aberrations, such as curvature of field, astigmatism, coma aberration, and distortion.

In the optical system of the present embodiment, the effect of the present embodiment can be ensured by setting the upper limit of conditional expression (5) to 3.95. To further ensure the effect of the present embodiment, the upper limit of conditional expression (5) is preferably set to 3.52 or 3.20, more preferably to 3.04.

If the value of conditional expression (5) is less than the lower limit in the optical system of the present embodiment, it will be difficult to correct aberrations, such as curvature of field, astigmatism, coma aberration, and distortion.

In the optical system of the present embodiment, the effect of the present embodiment can be ensured by setting the lower limit of conditional expression (5) to 0.41. To further ensure the effect of the present embodiment, the lower limit of conditional expression (5) is preferably set to 0.91 or 1.29, more preferably to 1.48.

Conditional expression (6) restricts the shape factor of an air lens formed between the image-plane-side lens surface of the second negative lens and an object-side lens surface of a lens disposed next to the second negative lens on the image plane side. The optical system of the present embodiment, which satisfies conditional expression (6), can correct aberrations, such as coma aberration, astigmatism, and curvature of field, appropriately and be easily manufactured.

If the value of conditional expression (6) is greater than the upper limit in the optical system of the present embodiment, it will be difficult to correct aberrations, such as coma aberration, astigmatism, and curvature of field.

In the optical system of the present embodiment, the effect of the present embodiment can be ensured by setting the upper limit of conditional expression (6) to 2.60. To further ensure the effect of the present embodiment, the upper limit of conditional expression (6) is preferably set to 2.39 or 2.24, more preferably to 2.16.

If the value of conditional expression (6) is less than the lower limit in the optical system of the present embodiment, it will be difficult to correct aberrations, such as coma aberration, astigmatism, and curvature of field. When the lens disposed next to the second negative lens on the image plane side is a positive lens, the rim will be thin, making it difficult to manufacture the optical system.

In the optical system of the present embodiment, the effect of the present embodiment can be ensured by setting the lower limit of conditional expression (6) to 0.30. To further ensure the effect of the present embodiment, the lower limit of conditional expression (6) is preferably set to 0.40 or 0.47, more preferably to 0.51.

An optical system satisfying conditional expressions (5), (6), and (4) is a wide-angle lens, and can avoid having a long total length, correct aberrations, such as, appropriately, and be easily manufactured.

An optical system of the present embodiment includes, in order from an object side, a first negative lens having negative refractive power, a second negative lens having negative refractive power, and a rear group, and satisfies the following conditional expressions.

$$( 7 ) 1.2 < ( - f 1 ) / f < 5.1 \\ ( 8 ) 1.91 < ( - f 2 ) / f < 7. \\ ( 9 ) 0.9 < T 112 / f < 8. \\ ( 4 ) 80. < 2 ω$$

where
f1: the focal length of the first negative lens
f: the focal length of the optical system
f2: the focal length of the second negative lens
T112: the total thickness on the optical axis from an object-side lens surface of the first negative lens to an image-plane-side lens surface of the second negative lens
2ω: the total field angle of the optical system

Conditional expression (7) restricts the ratio between the focal lengths of the first negative lens and the whole optical system. The optical system of the present embodiment, which satisfies conditional expression (7), can avoid the lens disposed closest to the object side having a large diameter and correct aberrations, such as curvature of field, astigmatism, and distortion, appropriately.

If the value of conditional expression (7) is greater than the upper limit in the optical system of the present embodiment, the diameter of the lens disposed closest to the object side will be too large, making it difficult to correct aberrations, such as curvature of field, astigmatism, and distortion.

In the optical system of the present embodiment, the effect of the present embodiment can be ensured by setting the upper limit of conditional expression (7) to 5.10. To further ensure the effect of the present embodiment, the upper limit of conditional expression (7) is preferably set to 3.19 or 1.75, more preferably to 1.04.

If the value of conditional expression (7) is less than the lower limit in the optical system of the present embodiment, it will be difficult to correct aberrations, such as curvature of field, astigmatism, and distortion.

In the optical system of the present embodiment, the effect of the present embodiment can be ensured by setting the lower limit of conditional expression (7) to 1.20. To further ensure the effect of the present embodiment, the lower limit of conditional expression (7) is preferably set to 0.82 or 0.54, more preferably to 0.39.

Conditional expression (8) restricts the ratio between the focal lengths of the negative lens and the whole optical system. The optical system of the present embodiment, which satisfies conditional expression (8), can correct aberrations, such as curvature of field and astigmatism, appropriately.

If the value of conditional expression (8) is greater than the upper limit in the optical system of the present embodiment, it will be difficult to correct aberrations, such as curvature of field and astigmatism.

In the optical system of the present embodiment, the effect of the present embodiment can be ensured by setting the upper limit of conditional expression (8) to 7.00. To further ensure the effect of the present embodiment, the upper limit of conditional expression (8) is preferably set to 6.45 or 6.04, more preferably to 5.84.

If the value of conditional expression (8) is less than the lower limit in the optical system of the present embodiment, it will be difficult to correct aberrations, such as curvature of field and astigmatism.

In the optical system of the present embodiment, the effect of the present embodiment can be ensured by setting the lower limit of conditional expression (8) to 1.91. To further ensure the effect of the present embodiment, the lower limit of conditional expression (8) is preferably set to 2.30 or 2.60, more preferably to 2.75.

Conditional expression (9) restricts the ratio of the total thickness on the optical axis from an object-side lens surface of the first negative lens to an image-plane-side lens surface of the second negative lens to the focal length of the optical system. The optical system of the present embodiment, which satisfies conditional expression (9), can avoid having a long total length and correct aberrations, such as curvature of field, astigmatism, coma aberration, and distortion, appropriately.

If the value of conditional expression (9) is greater than the upper limit in the optical system of the present embodiment, the total length of the optical system will be too long, making it difficult to correct aberrations, such as curvature of field, astigmatism, coma aberration, and distortion.

In the optical system of the present embodiment, the effect of the present embodiment can be ensured by setting the upper limit of conditional expression (9) to 8.00. To further ensure the effect of the present embodiment, the upper limit of conditional expression (9) is preferably set to 5.95 or 4.41, more preferably to 3.64.

If the value of conditional expression (9) is less than the lower limit in the optical system of the present embodiment, it will be difficult to correct aberrations, such as curvature of field, astigmatism, coma aberration, and distortion.

In the optical system of the present embodiment, the effect of the present embodiment can be ensured by setting the lower limit of conditional expression (9) to 0.90. To further ensure the effect of the present embodiment, the lower limit of conditional expression (9) is preferably set to 1.21 or 1.44, more preferably to 1.55.

An optical system satisfying conditional expressions (7), (8), (9), and (4) is a wide-angle lens, and can avoid having a long total length, avoid the lens disposed closest to the object side having a large diameter, and correct aberrations, such as curvature of field, astigmatism, coma aberration, and distortion, appropriately.

In the optical system of the present embodiment, the first negative lens, the second negative lens, and all lenses included in the rear group are preferably each configured as a single lens.

The optical system of the present embodiment with such a configuration can reduce the possibility of low performance caused by errors made during manufacture.

In the optical system of the present embodiment, all lenses included in the rear group preferably have positive refractive power.

The optical system of the present embodiment with such a configuration facilitates correction of aberrations, such as spherical aberration and coma aberration, and can ensure telecentricity on the image plane side.

The optical system of the present embodiment preferably satisfies the following conditional expression.

$$( 10 ) 0.5 < ( r 21 + r 12 ) / ( r 21 - r 12 ) < 8.$$

where
r12: the radius of curvature of an image-plane-side lens surface of the first negative lens
r21: the radius of curvature of an object-side lens surface of the second negative lens

Conditional expression (10) restricts the shape factor of an air lens formed between an image-plane-side lens surface of the first negative lens and an object-side lens surface of the second negative lens. The optical system of the present embodiment, which satisfies conditional expression (10), can correct aberrations, such as coma aberration, astigmatism, and curvature of field, appropriately and be easily manufactured.

If the value of conditional expression (10) is greater than the upper limit in the optical system of the present embodiment, it will be difficult to correct aberrations, such as coma aberration, astigmatism, and curvature of field.

In the optical system of the present embodiment, the effect of the present embodiment can be ensured by setting the upper limit of conditional expression (10) to 8.00. To further ensure the effect of the present embodiment, the upper limit of conditional expression (10) is preferably set to 7.19 or 6.58, more preferably to 6.28.

If the value of conditional expression (10) is less than the lower limit in the optical system of the present embodiment, it will be difficult to correct aberrations, such as coma aberration, astigmatism, and curvature of field. Further, the radius of curvature of the image-plane-side lens surface of the first negative lens will be small, making it difficult to manufacture the optical system.

In the optical system of the present embodiment, the effect of the present embodiment can be ensured by setting the lower limit of conditional expression (10) to 0.50. To further ensure the effect of the present embodiment, the lower limit of conditional expression (10) is preferably set to 0.65 or 0.77, more preferably to 0.83.

The optical system of the present embodiment preferably satisfies the following conditional expression.

$$( 11 ) 1. < f 3 / f < 80.$$

where
f3: the focal length of a lens disposed closest to the object side in the rear group

Conditional expression (11) restricts the ratio of the focal length of a lens disposed closest to the object side in the rear group to that of the whole optical system. The optical system of the present embodiment, which satisfies conditional expression (11), can correct aberrations, such as spherical aberration and coma aberration, appropriately.

If the value of conditional expression (11) is greater than the upper limit in the optical system of the present embodiment, it will be difficult to correct aberrations, such as spherical aberration and coma aberration.

In the optical system of the present embodiment, the effect of the present embodiment can be ensured by setting the upper limit of conditional expression (11) to 80.00. To further ensure the effect of the present embodiment, the upper limit of conditional expression (11) is preferably set to 78.65 or 77.64, more preferably to 77.14.

If the value of conditional expression (11) is less than the lower limit in the optical system of the present embodiment, it will be difficult to correct aberrations, such as spherical aberration and coma aberration.

In the optical system of the present embodiment, the effect of the present embodiment can be ensured by setting the lower limit of conditional expression (11) to 1.00. To further ensure the effect of the present embodiment, the lower limit of conditional expression (11) is preferably set to 2.33 or 3.32, more preferably to 3.82.

The optical system of the present embodiment preferably satisfies the following conditional expression.

$$( 12 ) - 30. < f 4 / f < 25.$$

where
f4: the focal length of a lens component disposed second closest to the object side in the rear group

Conditional expression (12) restricts the ratio of the focal length of a lens component disposed second closest to the object side in the rear group to that of the whole optical system. In the present specification, a “lens component” refers to a single lens or a cemented lens made by bonding multiple lenses together. The optical system of the present embodiment, which satisfies conditional expression (12), can correct aberrations, such as spherical aberration, coma aberration, and curvature of field, appropriately.

If the value of conditional expression (12) is greater than the upper limit in the optical system of the present embodiment, it will be difficult to correct aberrations, such as spherical aberration, coma aberration, and curvature of field.

In the optical system of the present embodiment, the effect of the present embodiment can be ensured by setting the upper limit of conditional expression (12) to 25.00. To further ensure the effect of the present embodiment, the upper limit of conditional expression (12) is preferably set to 23.68 or 22.70, more preferably to 22.20.

If the value of conditional expression (12) is less than the lower limit in the optical system of the present embodiment, it will be difficult to correct aberrations, such as spherical aberration, coma aberration, and curvature of field.

In the optical system of the present embodiment, the effect of the present embodiment can be ensured by setting the lower limit of conditional expression (12) to −30.00. To further ensure the effect of the present embodiment, the lower limit of conditional expression (12) is preferably set to −28.89 or −28.06, more preferably to −27.65.

Preferably, the rear group includes an aperture stop, and the optical system of the present embodiment satisfies the following conditional expression.

$$( 13 ) 2. < \vert fs - 1 \vert / f < 30.$$

where
fs−1: the focal length of a lens disposed next to the aperture stop on the object side

Conditional expression (13) restricts the ratio of the focal length of a lens disposed next to the aperture stop on the object side to that of the whole optical system. The optical system of the present embodiment, which satisfies conditional expression ( ) can correct aberrations, such as spherical aberration and coma aberration, appropriately.

If the value of conditional expression (13) is greater than the upper limit in the optical system of the present embodiment, it will be difficult to correct aberrations, such as spherical aberration and coma aberration.

In the optical system of the present embodiment, the effect of the present embodiment can be ensured by setting the upper limit of conditional expression (13) to 30.00. To further ensure the effect of the present embodiment, the upper limit of conditional expression (13) is preferably set to 28.92 or 28.12, more preferably to 27.71.

If the value of conditional expression (13) is less than the lower limit in the optical system of the present embodiment, it will be difficult to correct aberrations, such as spherical aberration and coma aberration.

In the optical system of the present embodiment, the effect of the present embodiment can be ensured by setting the lower limit of conditional expression (13) to 2.00. To further ensure the effect of the present embodiment, the lower limit of conditional expression (13) is preferably set to 2.63 or 3.10, more preferably to 3.34.

Preferably, the rear group includes an aperture stop, and the optical system of the present embodiment satisfies the following conditional expression.

$$( 14 ) 3. < ( fs + 1 ) / f < 25.$$

where
fs+1: the focal length of a lens component disposed next to the aperture stop on the image plane side

Conditional expression (14) restricts the ratio of the focal length of a lens component disposed next to the aperture stop on the image plane side to that of the whole optical system. The optical system of the present embodiment, which satisfies conditional expression (14), can correct aberrations, such as spherical aberration, coma aberration, and curvature of field, appropriately.

If the value of conditional expression (14) is greater than the upper limit in the optical system of the present embodiment, it will be difficult to correct aberrations, such as spherical aberration, coma aberration, and curvature of field.

In the optical system of the present embodiment, the effect of the present embodiment can be ensured by setting the upper limit of conditional expression (14) to 25.00. To further ensure the effect of the present embodiment, the upper limit of conditional expression (14) is preferably set to 22.18 or 20.07, more preferably to 19.01.

If the value of conditional expression (14) is less than the lower limit in the optical system of the present embodiment, it will be difficult to correct aberrations, such as spherical aberration, coma aberration, and curvature of field.

In the optical system of the present embodiment, the effect of the present embodiment can be ensured by setting the lower limit of conditional expression (14) to 3.00. To further ensure the effect of the present embodiment, the lower limit of conditional expression (14) is preferably set to 3.47 or 3.82, more preferably to 4.00.

The optical system of the present embodiment preferably satisfies the following conditional expression.

$$( 15 ) 0.3 ( - f 1 ) / fL < 2.$$

where
f1: the focal length of the first negative lens
fL: the focal length of a lens disposed closest to the image plane side

Conditional expression (15) restricts the ratio between the focal lengths of the first negative lens and a lens disposed closest to the image plane side. The optical system of the present embodiment, which satisfies conditional expression (15), can avoid having a long total length, avoid the lens disposed closest to the object side having a large diameter, and correct aberrations, such as curvature of field, astigmatism, distortion, and coma aberration, appropriately.

If the value of conditional expression (15) is greater than the upper limit in the optical system of the present embodiment, the first negative lens will have too weak negative refractive power and the diameter of the lens disposed closest to the object side will be increased, making it difficult to correct aberrations, such as curvature of field, astigmatism, and distortion.

In the optical system of the present embodiment, the effect of the present embodiment can be ensured by setting the upper limit of conditional expression (15) to 2.00. To further ensure the effect of the present embodiment, the upper limit of conditional expression (15) is preferably set to 1.33 or 0.82, more preferably to 0.40.

If the value of conditional expression (15) is less than the lower limit in the optical system of the present embodiment, the lens disposed closest to the image plane side will have too weak positive refractive power and the total length of the optical system will be increased, making it difficult to correct aberrations, such as curvature of field, coma aberration, and distortion.

In the optical system of the present embodiment, the effect of the present embodiment can be ensured by setting the lower limit of conditional expression (15) to 0.30. To further ensure the effect of the present embodiment, the lower limit of conditional expression (15) is preferably set to 0.28 or 0.27, more preferably to 0.26.

The optical system of the present embodiment preferably satisfies the following conditional expression.

$$( 16 ) 0.8 < D 112 / f < 3.$$

where
D112: the distance on the optical axis between an image-plane-side lens surface of the first negative lens and an object-side lens surface of the second negative lens

Conditional expression (16) restricts the ratio of the distance on the optical axis between an image-plane-side lens surface of the first negative lens and an object-side lens surface of the second negative lens to the focal length of the optical system. The optical system of the present embodiment, which satisfies conditional expression (16), can avoid having a long total length and correct aberrations, such as curvature of field, astigmatism, coma aberration, and distortion, appropriately.

If the value of conditional expression (16) is greater than the upper limit in the optical system of the present embodiment, the total length of the optical system will be too long, making it difficult to correct aberrations, such as curvature of field, astigmatism, and coma aberration.

In the optical system of the present embodiment, the effect of the present embodiment can be ensured by setting the upper limit of conditional expression (16) to 3.00. To further ensure the effect of the present embodiment, the upper limit of conditional expression (16) is preferably set to 2.00 or 1.00, more preferably to 0.70.

If the value of conditional expression (16) is less than the lower limit in the optical system of the present embodiment, it will be difficult to correct aberrations, such as distortion, curvature of field, and astigmatism.

In the optical system of the present embodiment, the effect of the present embodiment can be ensured by setting the lower limit of conditional expression (16) to 0.80. To further ensure the effect of the present embodiment, the lower limit of conditional expression (16) is preferably set to 0.58 or 0.41, more preferably to 0.33.

The optical system of the present embodiment preferably satisfies the following conditional expression.

$$( 17 ) 0.4 < - ( fn ) / fp < 1.5$$

where
fn: the combined focal length of the first and second negative lenses
fp: the focal length of the rear group

Conditional expression (17) restricts the ratio of the combined focal length of the first and second negative lenses to the focal length of the rear group. The optical system of the present embodiment, which satisfies conditional expression (17), can avoid having a long total length, avoid the lens disposed closest to the object side having a large diameter, and correct aberrations, such as curvature of field, distortion, and coma aberration, appropriately.

If the value of conditional expression (17) is greater than the upper limit in the optical system of the present embodiment, the first and second negative lenses will have too weak negative refractive power and the diameter of the lens disposed closest to the object side will be increased, making it difficult to correct aberrations, such as curvature of field and distortion.

In the optical system of the present embodiment, the effect of the present embodiment can be ensured by setting the upper limit of conditional expression (17) to 1.50. To further ensure the effect of the present embodiment, the upper limit of conditional expression (17) is preferably set to 1.23 or 1.03, more preferably to 0.92.

If the value of conditional expression (17) is less than the lower limit in the optical system of the present embodiment, the rear group will have too weak positive refractive power and the total length of the optical system will be increased, making it difficult to correct aberrations, such as curvature of field, coma aberration, and distortion.

In the optical system of the present embodiment, the effect of the present embodiment can be ensured by setting the lower limit of conditional expression (17) to 0.40. To further ensure the effect of the present embodiment, the lower limit of conditional expression (17) is preferably set to 0.41, more preferably to 0.42.

The optical system of the present embodiment preferably satisfies the following conditional expression.

$$( 18 ) 0.15 < D 112 / ( - f 1 ) < 0.8$$

where
D112: the distance on the optical axis between an image-plane-side lens surface of the first negative lens and an object-side lens surface of the second negative lens
f1: the focal length of the first negative lens

Conditional expression (18) restricts the ratio of the distance on the optical axis between an image-plane-side lens surface of the first negative lens and an object-side lens surface of the second negative lens to the focal length of the first negative lens. The optical system of the present embodiment, which satisfies conditional expression (18), can avoid having a long total length, avoid the lens disposed closest to the object side having a large diameter, and correct aberrations, such as curvature of field, astigmatism, coma aberration, and distortion, appropriately.

If the value of conditional expression (18) is greater than the upper limit in the optical system of the present embodiment, the total length of the optical system will be too long, making it difficult to correct aberrations, such as curvature of field, astigmatism, and coma aberration.

In the optical system of the present embodiment, the effect of the present embodiment can be ensured by setting the upper limit of conditional expression (18) to 0.800. To further ensure the effect of the present embodiment, the upper limit of conditional expression (18) is preferably set to 0.69 or 0.61, more preferably to 0.56.

If the value of conditional expression (18) is less than the lower limit in the optical system of the present embodiment, the first negative lens will have too weak negative refractive power and the diameter of the lens disposed closest to the object side will be increased, making it difficult to correct aberrations, such as distortion, curvature of field, and astigmatism.

In the optical system of the present embodiment, the effect of the present embodiment can be ensured by setting the lower limit of conditional expression (18) to 0.15. To further ensure the effect of the present embodiment, the lower limit of conditional expression (18) is preferably set to 0.19 or 0.21, more preferably to 0.23.

The optical system of the present embodiment preferably satisfies the following conditional expression.

$$( 19 ) 0.5 < D 112 / ( - fn ) < 1.5$$

where
D112: the distance on the optical axis between an image-plane-side lens surface of the first negative lens and an object-side lens surface of the second negative lens
fn: the combined focal length of the first and second negative lenses

Conditional expression (19) restricts the ratio of the distance on the optical axis between an image-plane-side lens surface of the first negative lens and an object-side lens surface of the second negative lens to the combined focal length of the first and second negative lenses. The optical system of the present embodiment, which satisfies conditional expression (19), can avoid having a long total length, avoid the lens disposed closest to the object side having a large diameter, and correct aberrations, such as curvature of field, astigmatism, coma aberration, and distortion, appropriately.

If the value of conditional expression (19) is greater than the upper limit in the optical system of the present embodiment, the total length of the optical system will be too long, making it difficult to correct aberrations, such as curvature of field, astigmatism, and coma aberration.

In the optical system of the present embodiment, the effect of the present embodiment can be ensured by setting the upper limit of conditional expression (19) to 1.50. To further ensure the effect of the present embodiment, the upper limit of conditional expression (19) is preferably set to 1.39 or 1.30, more preferably to 1.26.

If the value of conditional expression (19) is less than the lower limit in the optical system of the present embodiment, combined negative refractive power of the first and second negative lenses will be too weak and the diameter of the lens disposed closest to the object side will be increased, making it difficult to correct aberrations, such as distortion, curvature of field, and astigmatism.

In the optical system of the present embodiment, the effect of the present embodiment can be ensured by setting the lower limit of conditional expression (19) to 0.50. To further ensure the effect of the present embodiment, the lower limit of conditional expression (19) is preferably set to 0.54 or 0.57, more preferably to 0.58.

The optical system of the present embodiment preferably satisfies the following conditional expression.

$$( 20 ) 1.66 < n 1 < 2.3$$

where
n1: the refractive index of the first negative lens

Conditional expression (20) restricts the refractive index of the first negative lens. The optical system of the present embodiment, which satisfies conditional expression (20), can correct the curvature of field appropriately.

If the value of conditional expression (20) is greater than the upper limit in the optical system of the present embodiment, the first negative lens will have too strong negative refractive power, making it difficult to correct curvature of field.

In the optical system of the present embodiment, the effect of the present embodiment can be ensured by setting the upper limit of conditional expression (20) to 2.30. To further ensure the effect of the present embodiment, the upper limit of conditional expression (20) is preferably set to 2.20 or 2.10, more preferably to 2.05.

If the value of conditional expression (20) is less than the lower limit in the optical system of the present embodiment, the first negative lens will have too weak negative refractive power, making it difficult to correct curvature of field.

In the optical system of the present embodiment, the effect of the present embodiment can be ensured by setting the lower limit of conditional expression (20) to 1.66. To further ensure the effect of the present embodiment, the lower limit of conditional expression (20) is preferably set to 1.71 or 1.76, more preferably to 1.80.

The optical system of the present embodiment preferably satisfies the following conditional expression.

$$( 21 ) 1.66 < nL < 2.3$$

where
nL: the refractive index of a lens disposed closest to the image plane side

Conditional expression (21) restricts the refractive index of a lens disposed closest to the image plane side. The optical system of the present embodiment, which satisfies conditional expression (21), can correct aberrations, such as curvature of field, coma aberration, and distortion, appropriately.

If the value of conditional expression (21) is greater than the upper limit in the optical system of the present embodiment, the lens disposed closest to the image plane side will have too strong refractive power, making it difficult to correct aberrations, such as curvature of field, coma aberration, and distortion.

In the optical system of the present embodiment, the effect of the present embodiment can be ensured by setting the upper limit of conditional expression (21) to 2.30. To further ensure the effect of the present embodiment, the upper limit of conditional expression (21) is preferably set to 2.20 or 2.10, more preferably to 2.05.

If the value of conditional expression (21) is less than the lower limit in the optical system of the present embodiment, the lens disposed closest to the image plane side will have too weak refractive power, making it difficult to correct aberrations, such as curvature of field, coma aberration, and distortion.

In the optical system of the present embodiment, the effect of the present embodiment can be ensured by setting the lower limit of conditional expression (21) to 1.66. To further ensure the effect of the present embodiment, the lower limit of conditional expression (21) is preferably set to 1.71 or 1.76, more preferably to 1.80.

The optical system of the present embodiment preferably satisfies the following conditional expression.

$$1.6 6 < Naven < 2.3 \qquad ( 22 )$$

where
Naven: an average of the refractive indices of negative lenses included in the optical system

Conditional expression (22) restricts an average of the refractive indices of negative lenses included in the optical system. The optical system of the present embodiment, which satisfies conditional expression (22), can correct the curvature of field appropriately.

If the value of conditional expression (22) is greater than the upper limit in the optical system of the present embodiment, each negative lens included in the optical system will have too strong refractive power, making it difficult to correct curvature of field.

In the optical system of the present embodiment, the effect of the present embodiment can be ensured by setting the upper limit of conditional expression (22) to 2.30. To further ensure the effect of the present embodiment, the upper limit of conditional expression (22) is preferably set to 2.10, more preferably to 2.00.

If the value of conditional expression (22) is less than the lower limit in the optical system of the present embodiment, each negative lens included in the optical system will have too weak negative refractive power, making it difficult to correct curvature of field.

In the optical system of the present embodiment, the effect of the present embodiment can be ensured by setting the lower limit of conditional expression (22) to 1.66. To further ensure the effect of the present embodiment, the lower limit of conditional expression (22) is preferably set to 1.72, 1.78, or 1.82, more preferably to 1.90.

The optical system of the present embodiment preferably satisfies the following conditional expression.

$$1.6 6 < Nave < 2.3 \qquad ( 23 )$$

where
Nave: an average of the refractive indices of all the lenses included in the optical system

Conditional expression (23) restricts an average of the refractive indices of all the lenses included in the optical system. The optical system of the present embodiment, which satisfies conditional expression (23), can correct the curvature of field appropriately.

If the value of conditional expression (23) is greater than the upper limit in the optical system of the present embodiment, each lens included in the optical system will have too strong refractive power, making it difficult to correct curvature of field.

In the optical system of the present embodiment, the effect of the present embodiment can be ensured by setting the upper limit of conditional expression (23) to 2.30. To further ensure the effect of the present embodiment, the upper limit of conditional expression (23) is preferably set to 2.10, more preferably to 2.00.

If the value of conditional expression (23) is less than the lower limit in the optical system of the present embodiment, each lens included in the optical system will have too weak refractive power, making it difficult to correct curvature of field.

In the optical system of the present embodiment, the effect of the present embodiment can be ensured by setting the lower limit of conditional expression (23) to 1.66. To further ensure the effect of the present embodiment, the lower limit of conditional expression (23) is preferably set to 1.72, 1.78, or 1.82, more preferably to 1.90.

The optical system of the present embodiment preferably satisfies the following conditional expression.

$$2.2 < fL / f < 6. \qquad ( 24 )$$

where
fL: the focal length of a lens disposed closest to the image plane side

Conditional expression (24) restricts the ratio of the focal length of a lens disposed closest to the image plane side to that of the whole optical system. The optical system of the present embodiment, which satisfies conditional expression (24), can avoid having a long total length and correct aberrations, such as curvature of field, astigmatism, coma aberration, and distortion, appropriately.

If the value of conditional expression (24) is greater than the upper limit in the optical system of the present embodiment, the lens disposed closest to the image plane side will have weak positive refractive power and the total length of the optical system will be too long. Further, it will be difficult to correct aberrations, such as curvature of field, astigmatism, coma aberration, and distortion.

In the optical system of the present embodiment, the effect of the present

embodiment can be ensured by setting the upper limit of conditional expression (24) to 6.00. To further ensure the effect of the present embodiment, the upper limit of conditional expression (24) is preferably set to 5.47 or 5.07, more preferably to 4.87.

If the value of conditional expression (24) is less than the lower limit in the optical system of the present embodiment, the lens disposed closest to the image plane side will have strong positive refractive power, making it difficult to correct aberrations, such as curvature of field, coma aberration, and distortion.

In the optical system of the present embodiment, the effect of the present embodiment can be ensured by setting the lower limit of conditional expression (24) to 2.20. To further ensure the effect of the present embodiment, the lower limit of conditional expression (24) is preferably set to 2.40 or 2.56, more preferably to 2.64.

A small-sized optical system of favorable optical performance for light of a predetermined wavelength can be achieved by the above configuration.

An optical apparatus of the present embodiment includes an optical system configured as described above. This enables achieving an optical apparatus of favorable optical performance for light of a predetermined wavelength.

A method for manufacturing an optical system of the present disclosure is a method for manufacturing an optical system including, in order from an object side, a first negative lens having negative refractive power, a second negative lens having negative refractive power, and a rear group. The method includes disposing lenses so as to satisfy the following conditional expressions.

$$5.6 < TL / f < 13. \qquad ( 1 )$$

$$0.3 < f 1 / f 2 < 2. \qquad ( 2 )$$

$$1.6 6 < Nave 12 < 2.2 \qquad ( 3 )$$

$$80. < 2 ω \qquad ( 4 )$$

where
TL: the total length of the optical system
f: the focal length of the optical system
f1: the focal length of the first negative lens
f2: the focal length of the second negative lens
Nave12: an average of the refractive indices of the first and second negative lenses
2ω: the total field angle of the optical system

A method for manufacturing an optical system of the present disclosure is a method for manufacturing an optical system including, in order from an object side, a first negative lens having negative refractive power, a second negative lens having negative refractive power, and a rear group. The method includes disposing lenses so as to satisfy the following conditional expressions.

$$0.41 < T 112 / f < 3.95 \qquad ( 5 )$$

$$0.3 < ( r 31 + r 22 ) / ( r 31 - r 22 ) < 2.6 \qquad ( 6 )$$

$$80. < 2 ω \qquad ( 4 )$$

where
T112: the total thickness on the optical axis from an object-side lens surface of the first negative lens to an image-plane-side lens surface of the second negative lens
f: the focal length of the optical system
r22: the radius of curvature of the image-plane-side lens surface of the second negative lens
r31: the radius of curvature of an object-side lens surface of a lens disposed next to the second negative lens on the image plane side
2ω: the total field angle of the optical system

A method for manufacturing an optical system of the present disclosure is a method for manufacturing an optical system including, in order from an object side, a first negative lens having negative refractive power, a second negative lens having negative refractive power, and a rear group. The method includes disposing lenses so as to satisfy the following conditional expressions.

$$1.2 < ( - f 1 ) / f < 5.1 \qquad ( 7 )$$

$$1.91 < ( - f 2 ) / f < 7. \qquad ( 8 )$$

$$0.9 < T 112 / f < 8. \qquad ( 9 )$$

$$80. < 2 ω \qquad ( 4 )$$

where
f1: the focal length of the first negative lens
f: the focal length of the optical system
f2: the focal length of the second negative lens
T112: the total thickness on the optical axis from an object-side lens surface of the first negative lens to an image-plane-side lens surface of the second negative lens
2ω: the total field angle of the optical system

An optical system of favorable optical performance can be manufactured by such methods for manufacturing an optical system.

### NUMERICAL EXAMPLES

Examples of the present application will be described below with reference to the drawings.

### First Example

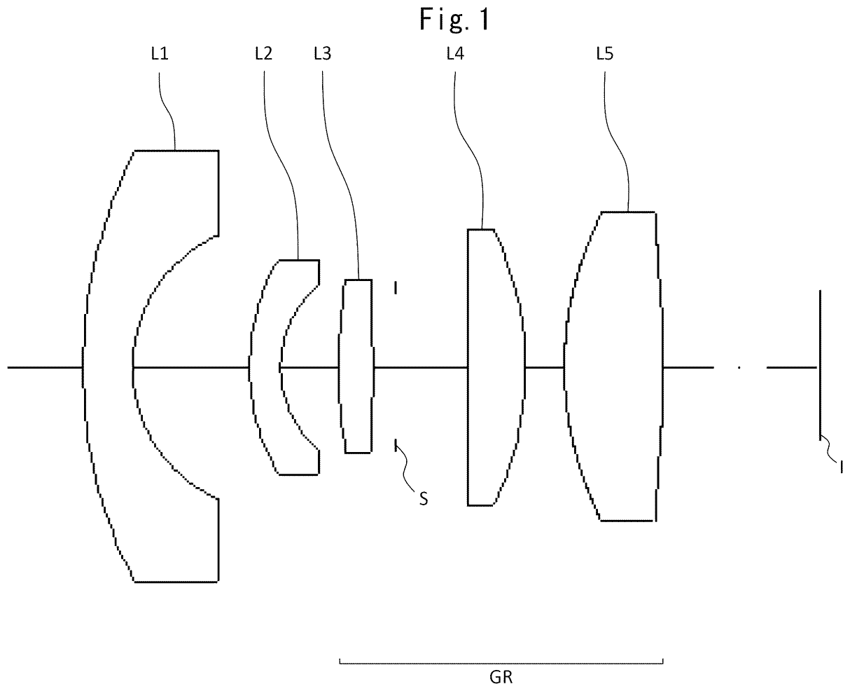

FIG. 1 is a cross-sectional view of an optical system of a first example focusing on an object at infinity.

The optical system of the present example includes, in order from the object side, meniscus-shaped negative lenses L1 and L2 convex on the object side, a biconvex positive lens L3, an aperture stop S, a meniscus-shaped positive lens L4 concave on the object side, and a biconvex positive lens L5.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the negative lenses L1 and L2 correspond to the first and second negative lenses, respectively. The positive lenses L3, L4, and L5 are included in the rear group.

Table 1 below shows specifications of the optical system of the present example. In [Lens specifications] of Table 1, m denotes the numbers of optical surfaces counted from the object side, r the radii of curvature, d the surface-to-surface distances, n(d) the refractive indices at d-line (wavelength 587.6 nm), n(s) the refractive indices at s-line (wavelength 852.1 nm), and νd the Abbe numbers based on d-line. The radius of curvature r=∞ means a plane. In [Lens specifications], the optical surfaces with “*” are aspherical surfaces.

In [Aspherical surface data], m denotes the optical surfaces corresponding to the aspherical surface data, K the conic constants, and A4 to A10 the aspherical coefficients.

The aspherical surfaces are expressed by expression (a) below, where y denotes the height in a direction perpendicular to the optical axis, S (y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is 0. “E−n” means “×10⁻ⁿ.”

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} \qquad ( a )$$

In [General specifications] of Table 1, f denotes the focal length of the optical system, TL the distance from the lens surface closest to the object side to the image plane at focusing on an object at infinity, Fno the f-number of the optical system, Ymax the maximum image height, and 2ω the total field angle (degrees). These values listed in [General specifications] are those at d-line.

The unit of the focal length f, the radii of curvature r, and the other lengths listed in Table 1 is “mm.” However, the unit is not limited thereto because the optical performance of a proportionally enlarged or reduced optical system is the same as that of the original optical system.

The above reference symbols in Table 1 will also be used similarly in the tables of the other examples described below.

TABLE 1
[Lens specifications]

| m | r | d | n(d) | n(s) | νd |
|---|---|---|---|---|---|
| 1) | 15.29287 | 1.600 | 2.001 | 1.975 | 29.12 |
| 2) | 4.64137 | 3.760 | | | |
| 3) | 6.85767 | 1.000 | 1.883 | 1.865 | 40.66 |
| 4) | 3.51122 | 1.870 | | | |
| 5) | 16.86126 | 1.090 | 2.001 | 1.975 | 29.12 |
| 6) | −150.37363 | 0.740 | | | |
| 7> | ∞ | 2.330 | | | (aperture stop) |
| 8) | −262.40513 | 1.840 | 2.001 | 1.975 | 29.12 |
| 9) | −10.12759 | 1.250 | | | |
| *10) | 10.67350 | 3.200 | 2.001 | 1.975 | 29.12 |
| *11) | −21.35376 | 4.811 | | | |

[Aspherical surface data]

| m | K | A4 | A6 | A8 | A10 |
|---|---|---|---|---|---|
| 10) | 0.2887 | 1.50E−04 | 6.00E−08 | −3.69E−08 | −6.71E−09 |
| 11) | 10.5353 | 9.44E−04 | −4.71E−06 | −2.75E−07 | 4.12E−10 |

[General specifications]

| | |
|---|---|
| f | 2.21 |
| TL | 23.49 |
| Fno | 1.17 |
| Ymax | 2.40 |
| 2ω | 126.86 |

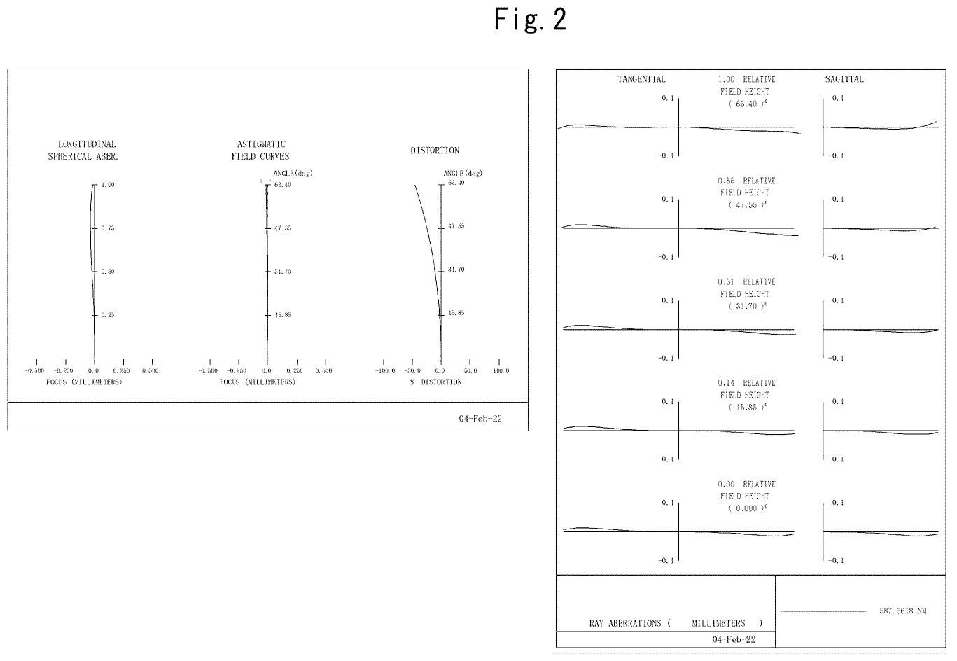

FIG. 2 shows aberrations of the optical system of the first example at d-line.

Of the graphs of aberrations, the graph of spherical aberration ( ) shows the ratio to the maximum aperture, the graphs of astigmatism and distortion (and DISTORTION) show the values at the semi-field angle, and the graphs of coma aberration show the ratio to the maximum image height. These graphs of aberrations show the values at d-line. In the graph of astigmatism, S and T indicate a sagittal plane and a meridional plane, respectively. The reference symbols in the graphs of aberrations of the present example will also be used in those of the other examples described below.

The graphs of aberrations suggest that the optical system of the present example corrects aberrations appropriately and has high optical performance at d-line.

### Second Example

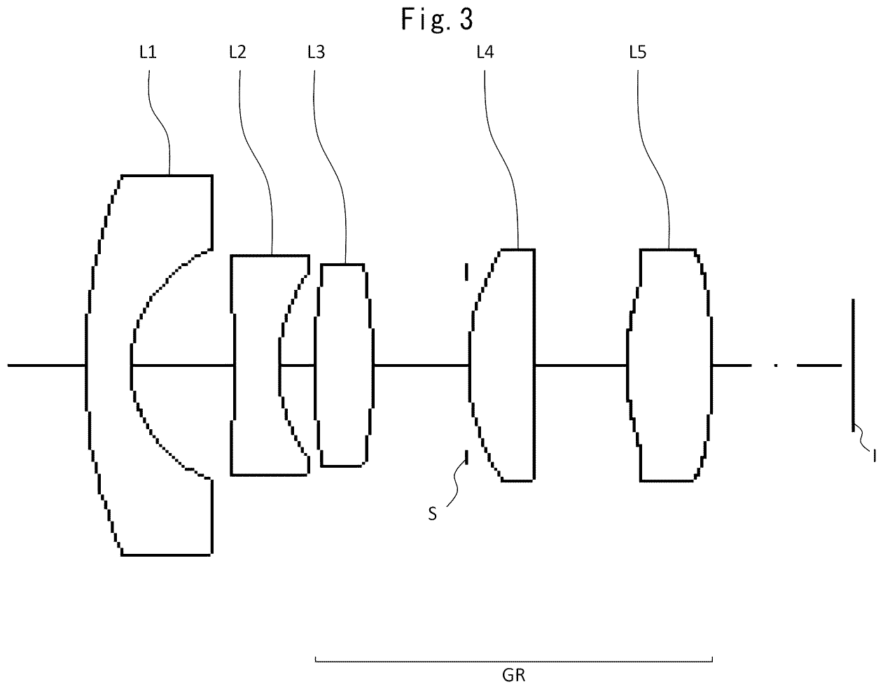

FIG. 3 is a cross-sectional view of an optical system of a second example focusing on an object at infinity.

The optical system of the present example includes, in order from the object side, a meniscus-shaped negative lens L1 convex on the object side, a biconcave negative lens L2, a biconvex positive lens L3, an aperture stop S, a meniscus-shaped positive lens L4 convex on the object side, and a biconvex positive lens L5.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the negative lenses L1 and L2 correspond to the first and second negative lenses, respectively. The positive lenses L3, L4, and L5 are included in the rear group.

Table 2 below shows specifications of the optical system of the present example.

TABLE 2
[Lens specifications]

| m | r | d | n(d) | n(s) | νd |
|---|---|---|---|---|---|
| 1) | 18.31206 | 1.400 | 1.835 | 1.819 | 42.73 |
| 2) | 4.28104 | 3.200 | | | |
| 3) | −69.66597 | 1.400 | 1.835 | 1.819 | 42.73 |
| 4) | 5.86107 | 1.110 | | | |
| 5) | 22.63692 | 1.800 | 1.835 | 1.819 | 42.73 |
| 6) | −20.84232 | 2.860 | | | |
| 7> | ∞ | 0.100 | | | (aperture stop) |
| 8) | 7.45717 | 2.000 | 1.835 | 1.819 | 42.73 |
| 9) | 168.26346 | 2.900 | | | |
| *10) | 7.85980 | 2.660 | 1.835 | 1.819 | 42.73 |
| *11) | −18.62590 | 4.405 | | | |

[Aspherical surface data]

| m | K | A4 | A6 | A8 | A10 |
|---|---|---|---|---|---|
| 10) | 0.6604 | −9.92E−04 | −7.28E−05 | 2.92E−06 | −3.79E−07 |
| 11) | 0.3766 | 5.99E−04 | −8.55E−05 | 2.89E−07 | −1.84E−08 |

[General specifications]

| | |
|---|---|
| f | 2.22 |
| TL | 23.83 |
| Fno | 1.19 |
| Ymax | 2.24 |
| 2ω | 118.86 |

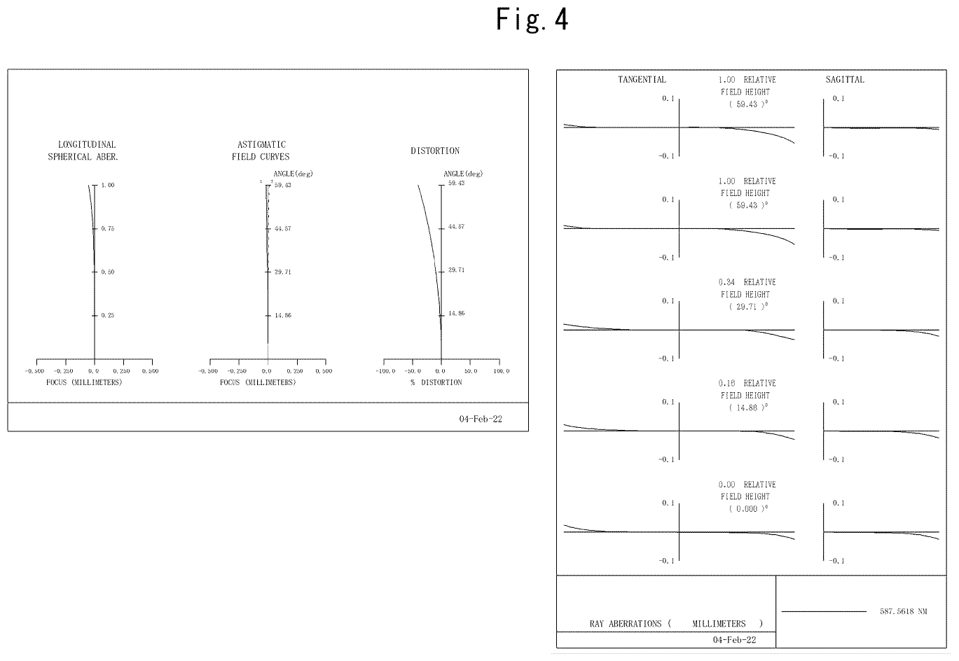

FIG. 4 shows aberrations of the optical system of the second example at d-line.

The graphs of aberrations suggest that the optical system of the present example corrects aberrations appropriately and has high optical performance at d-line.

### Third Example

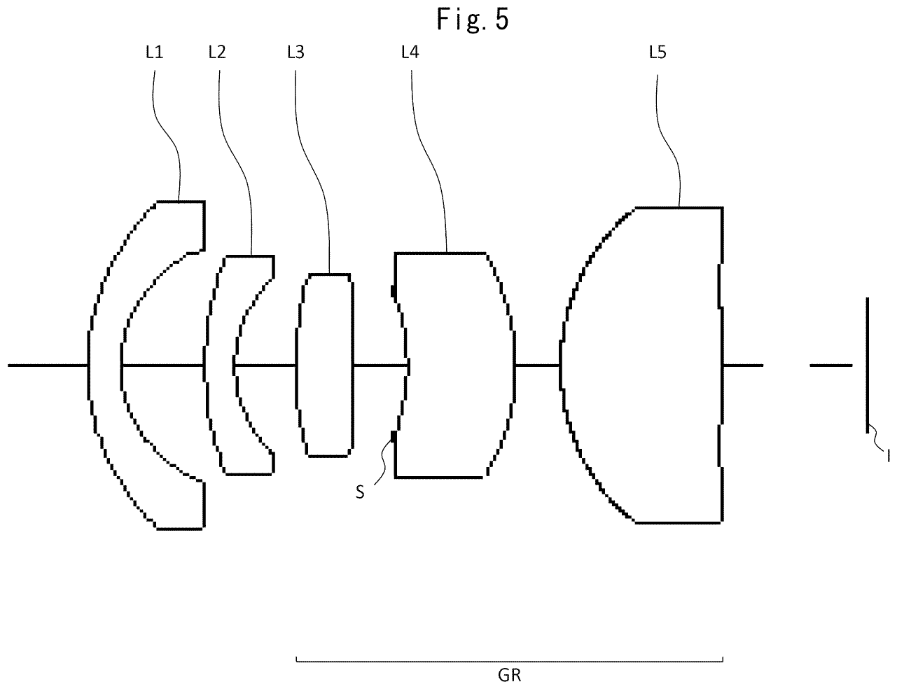

FIG. 5 is a cross-sectional view of an optical system of a third example focusing on an object at infinity.

The optical system of the present example includes, in order from the object side, meniscus-shaped negative lenses L1 and L2 convex on the object side, a biconvex positive lens L3, an aperture stop S, a meniscus-shaped negative lens L4 concave on the object side, and a biconvex positive lens L5.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the negative lenses L1 and L2 correspond to the first and second negative lenses, respectively. The positive lens L3, the negative lens L4, and the positive lens L5 are included in the rear group.

Table 3 below shows specifications of the optical system of the present example.

TABLE 3
[Lens specifications]

| m | r | d | n(d) | n(s) | νd |
|---|---|---|---|---|---|
| 1) | 7.83281 | 1.000 | 2.001 | 1.971 | 25.46 |
| 2) | 4.21943 | 2.560 | | | |
| 3) | 10.54627 | 0.900 | 1.835 | 1.819 | 42.73 |
| 4) | 4.24401 | 1.840 | | | |
| 5) | 12.10797 | 1.770 | 2.001 | 1.971 | 25.46 |
| 6) | −42.15743 | 1.110 | | | |
| 7> | ∞ | 0.500 | | | (aperture stop) |
| 8) | −7.45519 | 3.280 | 2.001 | 1.971 | 25.46 |
| 9) | −7.87407 | 1.360 | | | |
| *10) | 7.27535 | 4.900 | 2.001 | 1.971 | 25.46 |
| *11) | −22.76738 | 4.139 | | | |

[Aspherical surface data]

| m | K | A4 | A6 | A8 | A10 |
|---|---|---|---|---|---|
| 10) | 0.5975 | −2.78E−05 | 1.37E−05 | −1.65E−07 | 8.88E−09 |
| 11) | −6.5139 | 1.13E−03 | 1.10E−05 | 2.14E−07 | 8.12E−08 |

[General specifications]

| | |
|---|---|
| f | 2.67 |
| TL | 23.36 |
| Fno | 1.15 |
| Ymax | 2.24 |
| 2ω | 93.95 |

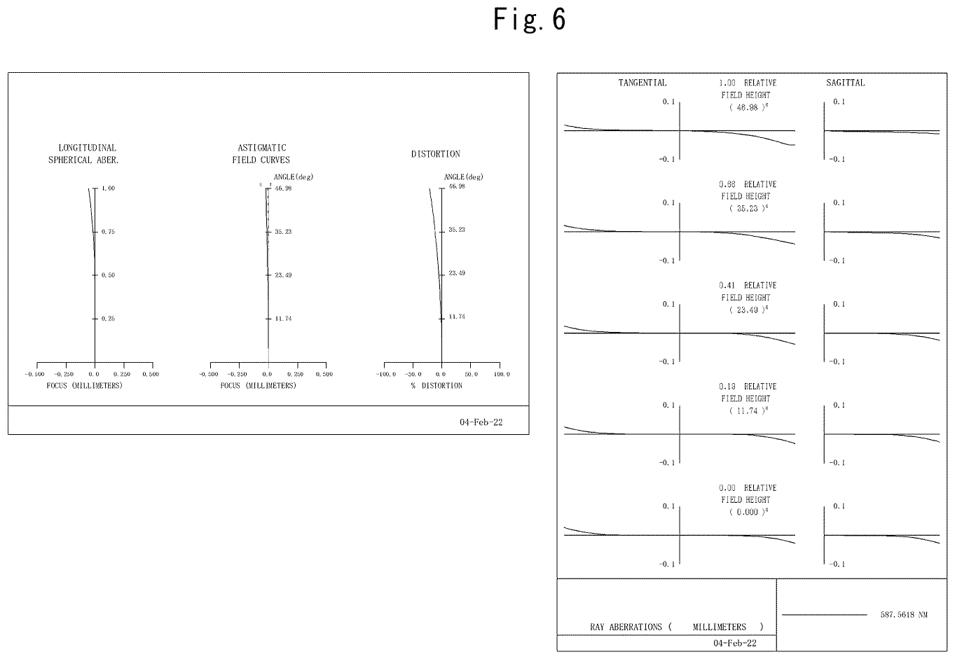

FIG. 6 shows aberrations of the optical system of the third example at d-line.

The graphs of aberrations suggest that the optical system of the present example corrects aberrations appropriately and has high optical performance at d-line.

### Fourth Example

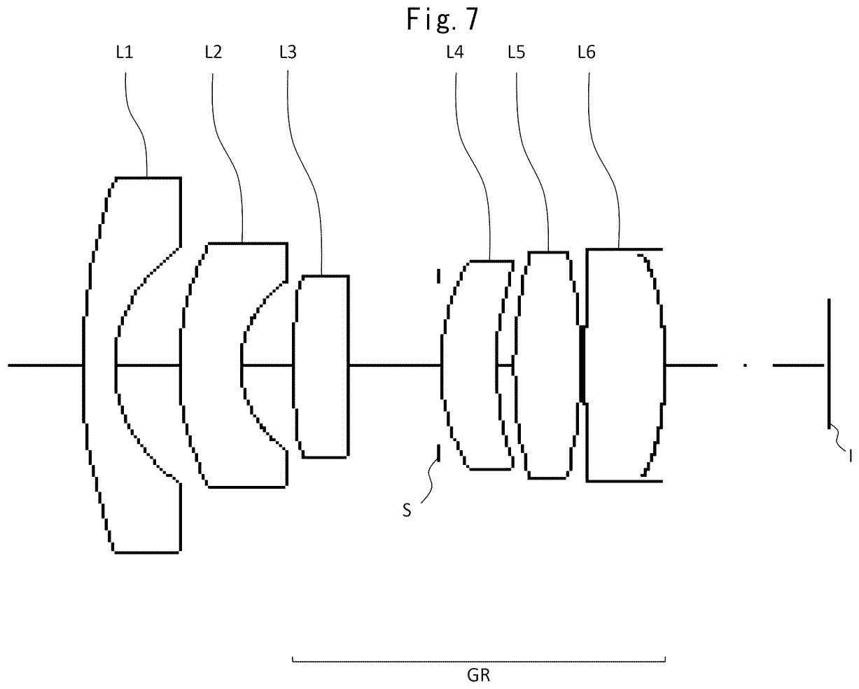

FIG. 7 is a cross-sectional view of an optical system of a fourth example focusing on an object at infinity.

The optical system of the present example includes, in order from the object side, meniscus-shaped negative lenses L1 and L2 convex on the object side, a meniscus-shaped positive lens L3 convex on the object side, an aperture stop S, a meniscus-shaped positive lens L4 convex on the object side, and biconvex positive lenses L5 and L6.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the negative lenses L1 and L2 correspond to the first and second negative lenses, respectively. The positive lenses L3, L4, L5, and L6 are included in the rear group.

Table 4 below shows specifications of the optical system of the present example.

TABLE 4
[Lens specifications]

| m | r | d | n(d) | n(s) | νd |
|---|---|---|---|---|---|
| 1) | 20.00000 | 1.000 | 1.835 | 1.819 | 42.73 |
| 2) | 4.84339 | 2.000 | | | |
| 3) | 9.40208 | 1.900 | 1.835 | 1.819 | 42.73 |
| 4) | 3.61501 | 1.600 | | | |
| 5) | 16.03674 | 1.690 | 1.835 | 1.819 | 42.73 |
| 6) | 71.13718 | 2.800 | | | |
| 7> | ∞ | 0.100 | | | (aperture stop) |
| 8) | 7.24833 | 1.720 | 1.883 | 1.866 | 40.66 |
| 9) | 10.08513 | 0.550 | | | |
| 10) | 14.74828 | 2.060 | 1.883 | 1.866 | 40.66 |
| 11) | −16.96499 | 0.100 | | | |
| *12) | 16.24374 | 2.510 | 1.883 | 1.866 | 40.66 |
| *13) | −12.52903 | 4.918 | | | |

[Aspherical surface data]

| m | K | A4 | A6 | A8 | A10 |
|---|---|---|---|---|---|
| 12) | 1.0110 | −1.37E−03 | 3.09E−05 | −1.45E−05 | 5.99E−07 |
| 13) | 11.3344 | 7.45E−04 | 4.55E−05 | −1.39E−05 | 1.01E−06 |

[General specifications]

| | |
|---|---|
| f | 2.23 |
| TL | 22.95 |
| Fno | 1.16 |
| Ymax | 2.24 |
| 2ω | 119.45 |

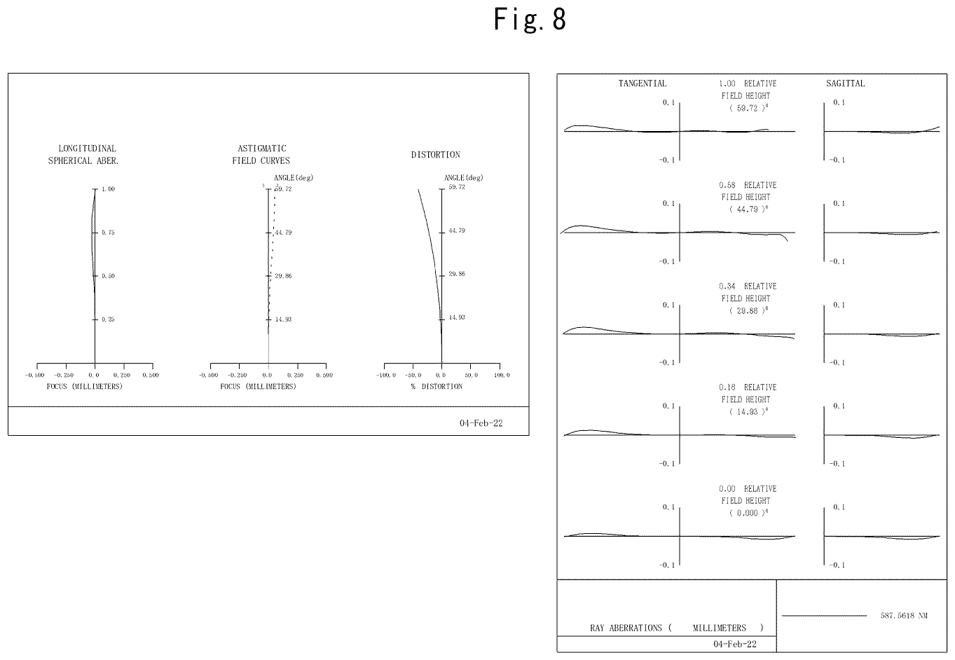

FIG. 8 shows aberrations of the optical system of the fourth example at d-line.

The graphs of aberrations suggest that the optical system of the present example corrects aberrations appropriately and has high optical performance at d-line.

### Fifth Example

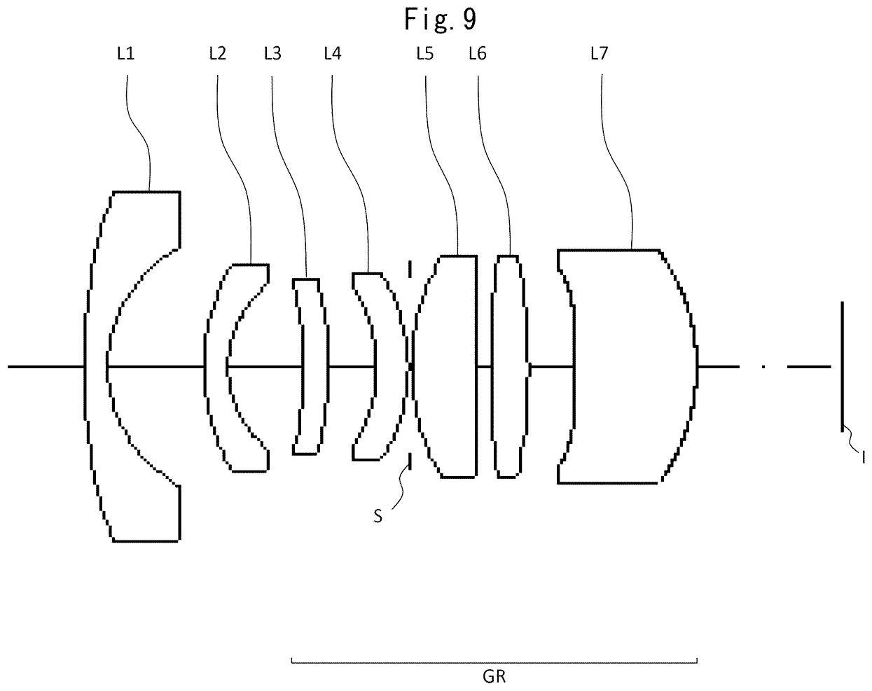

FIG. 9 is a cross-sectional view of an optical system of a fifth example focusing on an object at infinity.

The optical system of the present example includes, in order from the object side, meniscus-shaped negative lenses L1 and L2 convex on the object side, a meniscus-shaped positive lens L3 concave on the object side, a meniscus-shaped negative lens L4 concave on the object side, an aperture stop S, a meniscus-shaped positive lens L5 convex on the object side, a biconvex positive lens L6, and a meniscus-shaped positive lens L7 concave on the object side.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the negative lenses L1 and L2 correspond to the first and second negative lenses, respectively. The positive lens L3, the negative lens L4, and the positive lenses L5, L6, and L7 are included in the rear group.

Table 5 below shows specifications of the optical system of the present example.

TABLE 5
[Lens specifications]

| m | r | d | n(d) | n(s) | νd |
|---|---|---|---|---|---|
| 1) | 20.00000 | 0.750 | 1.835 | 1.819 | 42.73 |
| 2) | 4.83389 | 3.060 | | | |
| 3) | 7.66346 | 0.750 | 1.835 | 1.819 | 42.73 |
| 4) | 3.84085 | 2.400 | | | |
| 5) | −13.21260 | 0.790 | 1.835 | 1.819 | 42.73 |
| 6) | −12.41293 | 1.520 | | | |
| 7) | −5.34197 | 1.000 | 1.835 | 1.819 | 42.73 |
| 8) | −6.48598 | 0.050 | | | |
| 9> | ∞ | 0.050 | | | (aperture stop) |
| 10) | 7.76688 | 2.000 | 1.883 | 1.866 | 40.66 |
| 11) | 150.00000 | 0.500 | | | |
| 12) | 29.74606 | 1.200 | 1.883 | 1.866 | 40.66 |
| 13) | −21.97201 | 1.480 | | | |
| 14) | −87.70055 | 3.840 | 1.883 | 1.866 | 40.66 |
| 15) | −7.47766 | 4.453 | | | |

[Aspherical surface data]

| m | K | A4 | A6 | A8 | A10 |
|---|---|---|---|---|---|
| 14) | 11.0000 | −2.72E−03 | −6.16E−05 | −3.80E−06 | 3.25E−07 |
| 15) | 2.3516 | 2.02E−04 | −3.08E−07 | 8.77E−07 | 6.99E−08 |

[General specifications]

| | |
|---|---|
| f | 2.21 |
| TL | 23.84 |
| Fno | 1.18 |
| Ymax | 2.24 |
| 2ω | 119.12 |

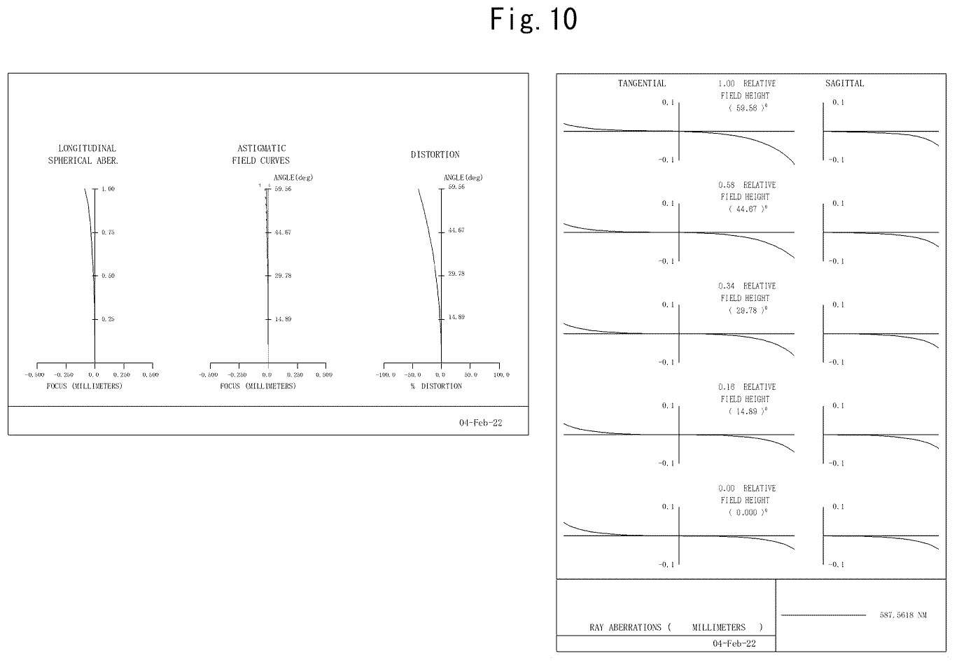

FIG. 10 shows aberrations of the optical system of the fifth example at d-line.

The graphs of aberrations suggest that the optical system of the present example corrects aberrations appropriately and has high optical performance at d-line.

### Sixth Example

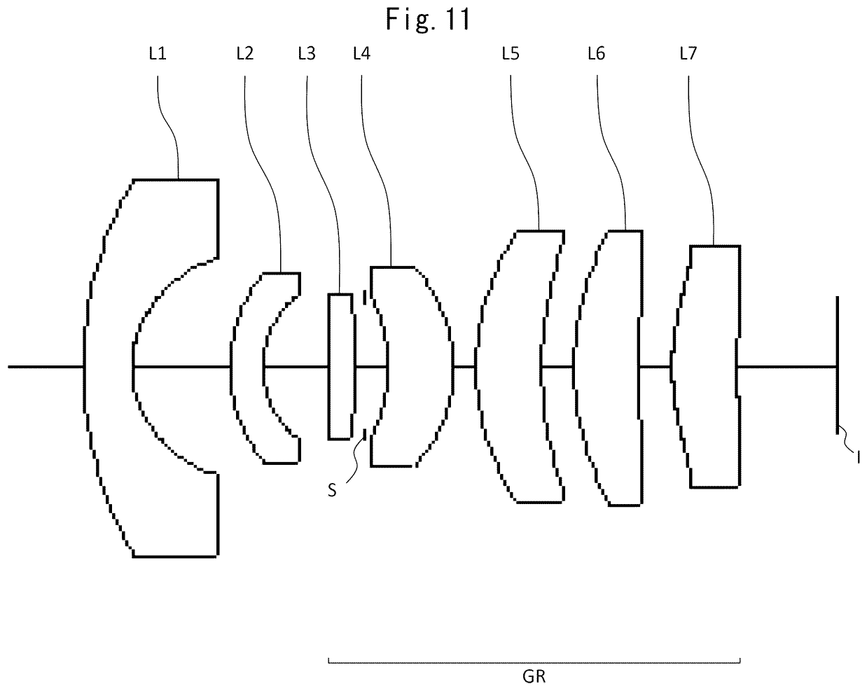

FIG. 11 is a cross-sectional view of an optical system of a sixth example focusing on an object at infinity.

The optical system of the present example includes, in order from the object side, meniscus-shaped negative lenses L1 and L2 convex on the object side, a biconvex positive lens L3, an aperture stop S, a meniscus-shaped positive lens L4 concave on the object side, and meniscus-shaped positive lenses L5, L6, and L7 convex on the object side.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the negative lenses L1 and L2 correspond to the first and second negative lenses, respectively. The positive lenses L3, L4, L5, L6, and L7 are included in the rear group.

Table 6 below shows specifications of the optical system of the present example.

TABLE 6
[Lens specifications]

| m | r | d | n(d) | n(s) | νd |
|---|---|---|---|---|---|
| 1) | 13.25000 | 1.500 | 1.835 | 1.819 | 42.73 |
| 2) | 3.77967 | 3.000 | | | |
| 3) | 5.29961 | 1.000 | 1.835 | 1.819 | 42.73 |
| 4) | 3.19753 | 2.000 | | | |
| 5) | 77.00499 | 0.850 | 1.835 | 1.819 | 42.73 |
| 6) | −18.80941 | 0.300 | | | |
| 7> | ∞ | 0.700 | | | (aperture stop) |
| 8) | −5.61864 | 2.000 | 1.883 | 1.866 | 40.66 |
| 9) | −5.08553 | 0.700 | | | |
| 10) | 8.46722 | 2.000 | 1.883 | 1.866 | 40.66 |
| 11) | 13.25226 | 1.000 | | | |
| 12) | 10.00000 | 2.000 | 1.883 | 1.866 | 40.66 |
| 13) | 100.00000 | 1.000 | | | |
| *14) | 8.77854 | 2.000 | 1.883 | 1.866 | 40.66 |
| *15) | 209.81181 | 2.918 | | | |

[Aspherical surface data]

| m | K | A4 | A6 | A8 | A10 |
|---|---|---|---|---|---|
| 14) | −0.7480 | −4.07E−05 | −4.48E−05 | −4.00E−06 | 1.71E−07 |
| 15) | −9.0000 | 1.15E−03 | −8.15E−05 | −7.33E−06 | 5.66E−07 |

[General specifications]

| | |
|---|---|
| f | 2.19 |
| TL | 22.97 |
| Fno | 1.18 |
| Ymax | 2.24 |
| 2ω | 118.75 |

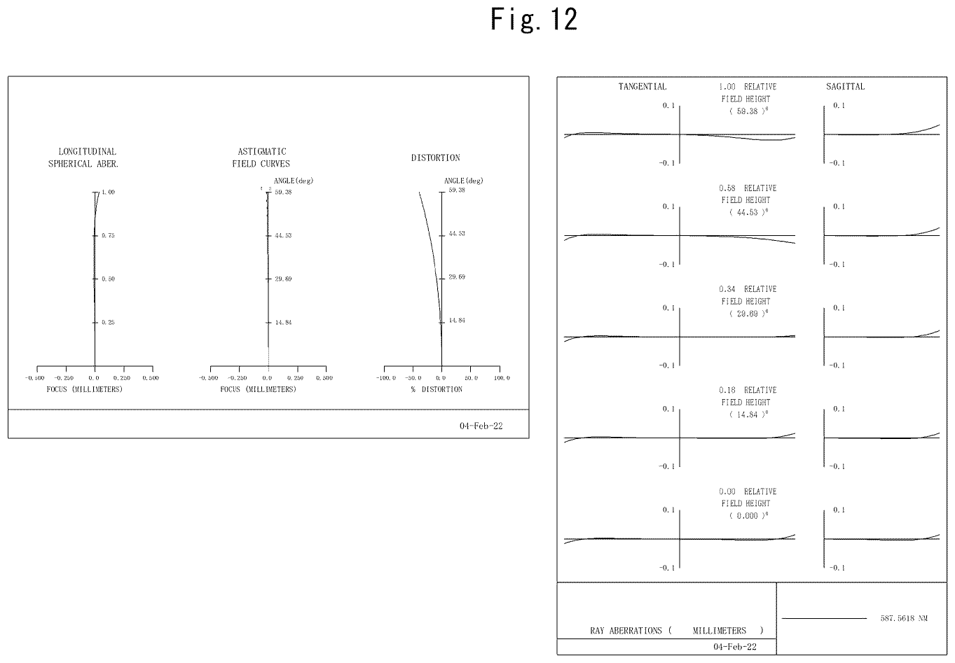

FIG. 12 shows aberrations of the optical system of the sixth example at d-line.

The graphs of aberrations suggest that the optical system of the present example corrects aberrations appropriately and has high optical performance at d-line.

### Seventh Example

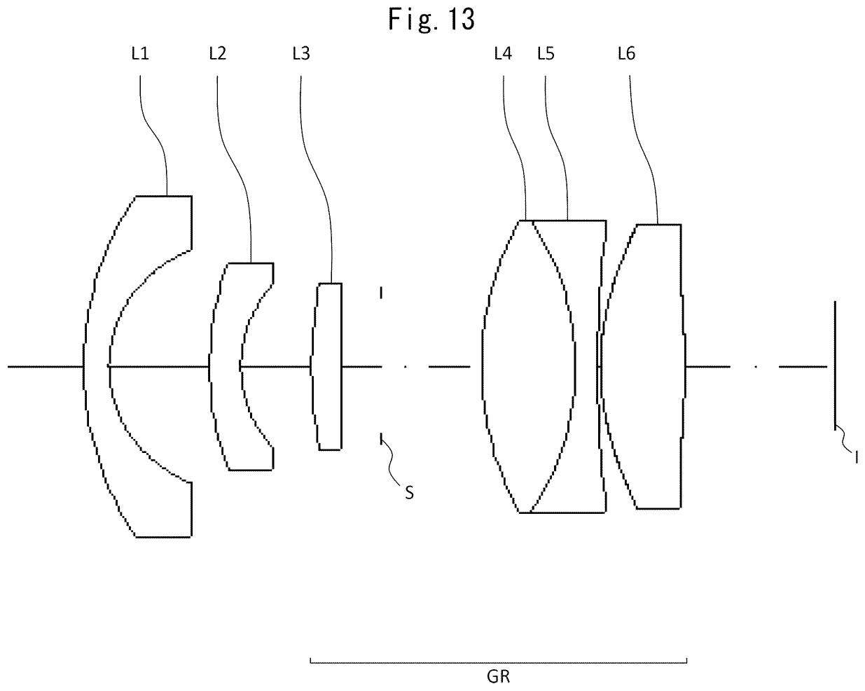

FIG. 13 is a cross-sectional view of an optical system of a seventh example focusing on an object at infinity.

The optical system of the present example includes, in order from the object side, meniscus-shaped negative lenses L1 and L2 convex on the object side, a biconvex positive lens L3, an aperture stop S, a positive cemented lens composed of a biconvex positive lens L4 and a biconcave negative lens L5, and a biconvex positive lens L6.

An imaging device (not shown) constructed from CCD, CMOS, or the like is disposed on an image plane I.

The optical system of the present example focuses by moving the whole optical system along the optical axis. When focus is shifted from infinity to a nearby object, the optical system of the present example moves from the image plane side toward the object side.

In the optical system of the present example, the negative lenses L1 and L2 correspond to the first and second negative lenses, respectively. The positive lenses L3 and L4, the negative lens L5, and the positive lens L6 are included in the rear group.

Table 7 below shows specifications of the optical system of the present example.

TABLE 7
[Lens specifications]

| m | r | d | n(d) | n(s) | νd |
|---|---|---|---|---|---|
| 1) | 11.37680 | 0.800 | 2.001 | 1.975 | 29.12 |
| 2) | 4.42330 | 3.220 | | | |
| 3) | 11.23280 | 1.000 | 1.883 | 1.866 | 40.66 |
| 4) | 4.49160 | 2.250 | | | |
| 5) | 15.21610 | 0.980 | 2.001 | 1.975 | 29.12 |
| 6) | −515.67040 | 1.250 | | | |
| 7> | ∞ | 3.200 | | | (aperture stop) |
| 8) | 10.98310 | 3.000 | 2.001 | 1.975 | 29.12 |
| 9) | −9.66050 | 0.700 | 1.847 | 1.820 | 23.80 |
| 10) | 42.40840 | 0.100 | | | |
| *11) | 9.54880 | 2.700 | 2.001 | 1.975 | 29.12 |
| *12) | −22.30040 | 4.591 | | | |

[Aspherical surface data]

| m | K | A4 | A6 | A8 | A10 |
|---|---|---|---|---|---|
| 11) | 9.5488 | 1.41E−04 | −2.32E−07 | −5.33E−08 | −4.47E−09 |
| 12) | −22.3004 | 9.50E−04 | −5.74E−06 | −1.35E−07 | 2.93E−09 |

[General specifications]

| | |
|---|---|
| f | 2.16 |
| TL | 23.79 |
| Fno | 1.16 |
| Ymax | 2.24 |
| 2ω | 118.80 |

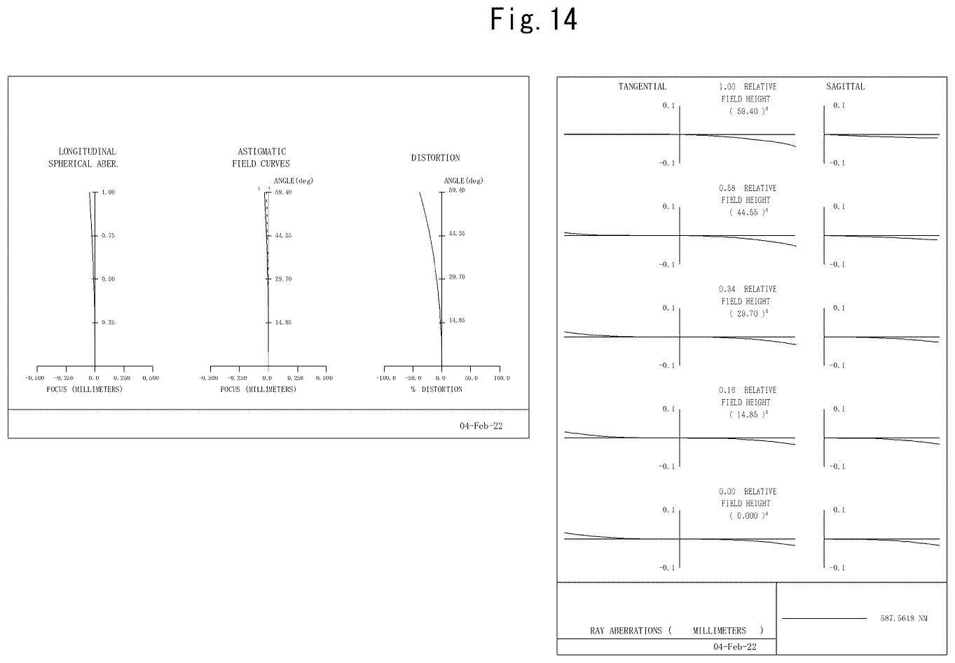

FIG. 14 shows aberrations of the optical system of the seventh example at d-line.

The graphs of aberrations suggest that the optical system of the present example corrects aberrations appropriately and has high optical performance at d-line.

An optical system of favorable optical performance can be achieved according to the above examples.

Values for the conditional expressions of the examples are listed below.

TL is the total length of the optical system; f is the focal length of the optical system. f1 and f2 are the focal lengths of the first and second negative lenses, respectively. Nave12 is an average of the refractive indices of the first and second negative lenses. 20 is the total field angle of the optical system.

r12 is the radius of curvature of an image-plane-side lens surface of the first negative lens; r21 is the radius of curvature of an object-side lens surface of the second negative lens. f3 is the focal length of a lens disposed closest to the object side in the rear group. f4 is the focal length of a lens component disposed second closest to the object side in the rear group.

fs−1 is the focal length of a lens disposed next to the aperture stop on the object side. fs+1 is the focal length of a lens component disposed next to the aperture stop on the image plane side. fL is the focal length of a lens disposed closest to the image plane side.

D112 is the distance on the optical axis between an image-plane-side lens surface of the first negative lens and an object-side lens surface of the second negative lens. fn is the combined focal length of the first and second negative lenses; fp is the focal length of the rear group.

n1 is the refractive index of the first negative lens. nL is the refractive index of a lens disposed closest to the image plane side. Naven is an average of the refractive indices of negative lenses included in the optical system. Nave is an average of the refractive indices of all the lenses included in the optical system.

The values listed in [Values for conditional expressions] are those at d-line.

### [Values for Conditional Expressions]

| Conditional | | | | | |
|---|---|---|---|---|---|
| expressions | Examples | First | Second | Third | Fourth |
| (1) | TL/f | 10.621 | 10.749 | 8.734 | 10.294 |
| (2) | f1/f2 | 0.760 | 1.092 | 1.166 | 0.954 |
| (3) | Nave12 | 1.942 | 1.835 | 1.918 | 1.835 |
| (4) | 2ω | 126.858 | 118.860 | 93.954 | 119.446 |
| (5)(9) | T112/f | 2.876 | 2.706 | 1.668 | 2.198 |
| (6) | (r31 + r22)/ | 1.526 | 1.699 | 2.079 | 1.582 |
| | (r31 − r22) | | | | |
| (7) | −(f1)/f | 3.254 | 3.162 | 3.967 | 3.540 |
| (8) | −(f2)/f | 4.285 | 2.896 | 3.402 | 3.710 |
| (10) | (r21 + r12)/ | 5.188 | 0.884 | 2.334 | 3.125 |
| | (r21 − r12) | | | | |
| (11) | f3/f | 6.870 | 5.974 | 3.573 | 10.972 |
| (12) | f4/f | 4.741 | 4.191 | 17.954 | 10.193 |
| (13) | \|fs − 1\|/f | 6.870 | 5.974 | 3.573 | 10.972 |
| (14) | (fs + 1)/f | 4.741 | 4.191 | 17.954 | 10.193 |
| (15) | −(f1)/fL | 0.962 | 1.011 | 1.768 | 0.945 |
| (16) | D112/f | 1.700 | 1.443 | 0.957 | 0.897 |
| (17) | −(fn)/fp | 0.625 | 0.428 | 0.822 | 0.638 |
| (18) | D112/−(f1) | 0.522 | 0.456 | 0.241 | 0.253 |
| (19) | D112/−(fn) | 1.175 | 1.214 | 0.596 | 0.612 |
| (20) | n1 | 2.001 | 1.835 | 2.001 | 1.835 |
| (21) | nL | 2.001 | 1.835 | 2.001 | 1.883 |
| (22) | Naven | 1.942 | 1.835 | 1.918 | 1.835 |
| (23) | Nave | 1.942 | 1.835 | 1.945 | 1.835 |
| (24) | fL/f | 3.383 | 3.129 | 2.243 | 3.747 |

| Conditional | | | | |
|---|---|---|---|---|
| expression | Examples | Fifth | Sixth | Seventh |
| (1) | TL/f | 10.811 | 10.500 | 10.999 |
| (2) | f1/f2 | 0.771 | 0.554 | 0.842 |
| (3) | Nave12 | 1.835 | 1.835 | 1.942 |
| (4) | 2ω | 119.125 | 118.752 | 118.800 |
| (5)(9) | T112/f | 2.068 | 2.514 | 2.321 |
| (6) | (r31 + r22)/ | 0.550 | 1.087 | 1.838 |
| | (r31 − r22) | | | |
| (7) | −(f1)/f | 3.542 | 3.121 | 3.547 |
| (8) | −(f2)/f | 4.592 | 5.634 | 4.212 |
| (10) | (r21 + r12)/ | 4.417 | 5.973 | 2.299 |
| | (r21 − r12) | | | |
| (11) | f3/f | 76.849 | 8.312 | 6.833 |
| (12) | f4/f | −27.311 | 10.057 | 5.224 |
| (13) | \|fs − 1\|/f | 27.311 | 8.312 | 6.833 |
| (14) | (fs + 1)/f | 4.179 | 10.057 | 5.224 |
| (15) | −(f1)/fL | 0.863 | 0.661 | 1.100 |
| (16) | D112/f | 1.387 | 1.371 | 1.489 |
| (17) | −(fn)/fp | 0.705 | 0.766 | 0.603 |
| (18) | D112/−(f1) | 0.392 | 0.439 | 0.420 |
| (19) | D112/−(fn) | 0.842 | 0.840 | 0.953 |
| (20) | n1 | 1.835 | 1.835 | 2.001 |
| (21) | nL | 1.883 | 1.883 | 2.001 |
| (22) | Naven | 1.835 | 1.835 | 1.942 |
| (23) | Nave | 1.835 | 1.835 | 1.962 |
| (24) | fL/f | 4.105 | 4.721 | 3.225 |

The above examples are specific examples of the present invention, and the present invention is not limited thereto. The following details can be appropriately employed unless the optical performance of the optical system of the embodiment of the present application is compromised.

Next, a range finder including the optical system of the present embodiment will be described with reference to FIG.

FIG. schematically shows a range finder 1 including an optical system of the present embodiment.

The range finder 1 includes the optical system according to the first example as a receiving optical system 3.

In the range finder 1, light of a predetermined wavelength emitted from a light source 2 and reflected by an object (target for distance measurement) (not shown) is received by the receiving optical system 3 and reaches a photodetector 4. The photodetector 4 converts the light from the target to data. The range finder 1 detects the distance to the target, based on the time from when light is emitted from the light source 2 until light reflected by the target is received.

The light source 2 emits light of a wavelength in the range from visible light to near-infrared light. Light emitted from the light source 2 is preferably near-infrared light so as not to affect the appearance of images of objects.

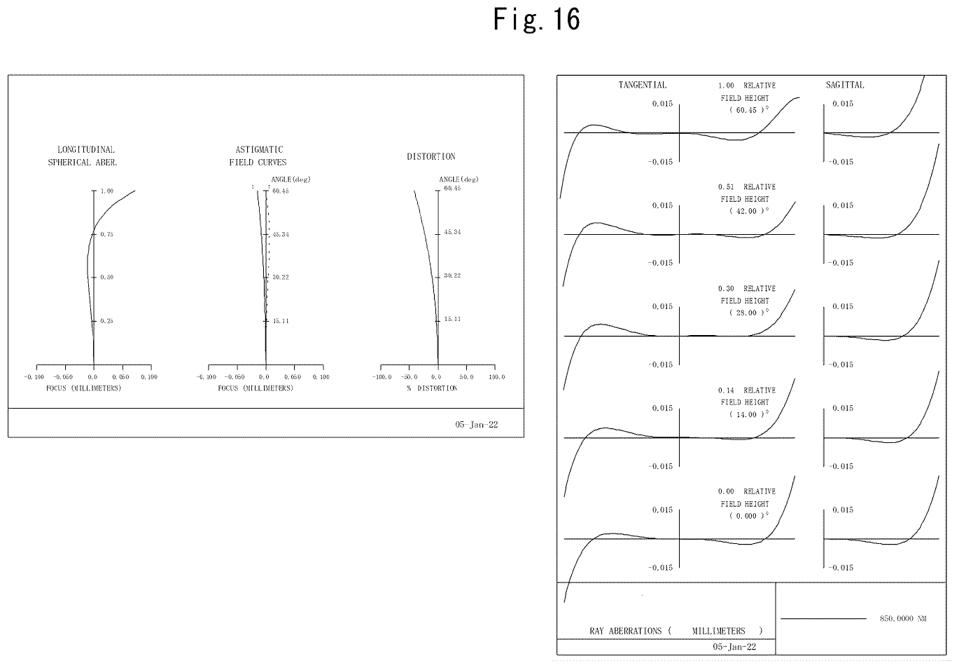

FIG. 16 shows aberrations of the optical system of the first example at s-line. The optical system of the first example corrects aberrations (spherical aberration) at s-line in a balanced manner so that the value of a modulation transfer function (MTF) does not decrease rapidly even at a position away in a defocusing direction from the Gaussian image plane. It is suggested that the range finder 1 has favorable optical performance at s-line. The scale of the graphs of aberrations shown in FIG. 16 differs from that of the graphs of aberrations of the examples at d-line shown in FIGS. 2, 4, 6, 8, 10, 12, and 14.

The optical system of the first example included in the range finder 1 as the receiving optical system 3 is an optical system of favorable optical performance at s-line. Thus the range finder 1 has favorable optical performance at s-line and can achieve accurate distance measurement. A range finder configured by including one of the optical systems of the second to seventh examples as the receiving optical system 3 can have the same effect as the range finder 1 for light of wavelengths at which the respective optical systems have favorable optical performance.

Finally, a method for manufacturing an optical system of the present embodiment will be outlined with reference to FIG. FIG. is a flowchart outlining a method for manufacturing an optical system of the present embodiment.

The method for manufacturing an optical system of the present embodiment shown in FIG. includes steps S1 and S2 below.

Step S1: a, a second negative lens, and a rear group are prepared.

Step S2: the optical system is made to satisfy the following conditional expressions.

$$5.6 < TL / f < 13. \qquad ( 1 )$$

$$0.3 < f 1 / f 2 < 2. \qquad ( 2 )$$

$$1.6 6 < Nave 12 < 2.2 \qquad ( 3 )$$

$$80. < 2 ω \qquad ( 4 )$$

where
TL: the total length of the optical system
f: the focal length of the optical system
f1: the focal length of the first negative lens
f2: the focal length of the second negative lens
Nave12: an average of the refractive indices of the first and second negative lenses
2ω: the total field angle of the optical system

In a modified example, step S2A below may be performed instead of step S2 in the method for manufacturing an optical system shown in FIG.

Step S2A: the optical system is made to satisfy the following conditional expressions.

$$0.41 < T 112 / f < 3.95 \qquad ( 5 )$$

$$0.3 < ( r 31 + r 22 ) / ( r 31 - r 22 ) < 2.6 \qquad ( 6 )$$

$$80. < 2 ω \qquad ( 4 )$$

where
T112: the total thickness on the optical axis from an object-side lens surface of the first negative lens to an image-plane-side lens surface of the second negative lens
f: the focal length of the optical system
r22: the radius of curvature of the image-plane-side lens surface of the second negative lens
r31: the radius of curvature of an object-side lens surface of a lens disposed next to the second negative lens on the image plane side
2ω: the total field angle of the optical system

In another modified example, step S2B below may be performed instead of step S2 the method for manufacturing an optical system shown in FIG.

Step S2B: the optical system is made to satisfy the following conditional expressions.

$$1.2 < ( - f 1 ) / f < 5.1 \qquad ( 7 )$$

$$1.91 < ( - f 2 ) / f < 7. \qquad ( 8 )$$

$$0.9 < T 112 / f < 8. \qquad ( 9 )$$

$$80. < 2 ω \qquad ( 4 )$$

where
f1: the focal length of the first negative lens
f: the focal length of the optical system
f2: the focal length of the second negative lens
T112: the total thickness on the optical axis from an object-side lens surface of the first negative lens to an image-plane-side lens surface of the second negative lens
2ω: the total field angle of the optical system

An optical system of favorable imaging performance can be manufactured by these methods for manufacturing an optical system of the present embodiment.

In the optical system of the present embodiment, lens surfaces may be spherical, plane, or aspherical surfaces. Spherical or plane lens surfaces are preferable because they facilitate lens machining, assembling, and adjustment and prevent a decrease in optical performance caused by errors in machining, assembling, and adjustment and because depiction performance does not decrease much when the image plane is shifted.

An aspherical lens surface may be formed by grinding glass or glass molding with a mold having an aspherical shape, or formed on the surface of resin bonded on a glass surface. In the optical system of the present embodiment, lens surfaces may be diffractive surfaces, and lenses may be graded index lenses (GRIN lenses) or plastic lenses.

Without including a separate member serving as the aperture stop, the optical system of the present embodiment may use a lens frame or the like as a substitute.

Regarding the above embodiment, the following notes will be further disclosed.

### [Note 1]

The optical system of the present embodiment may satisfy the following conditional expression.

$$1.6 6 < nL < 2.3$$

where
nL: the refractive index of a lens disposed closest to the image plane side

### [Note 2]

The optical system of the present embodiment may satisfy the following conditional expression.

$$1.6 6 < Naven < 2.3$$

where
Naven: an average of the refractive indices of negative lenses included in the optical system

### [Note 3]

The optical system of the present embodiment may satisfy the following conditional expression.

$$1.6 6 < Nave < 2.3$$

where
Nave: an average of the refractive indices of all the lenses included in the optical system

It should be noted that those skilled in the art can make various changes, substitutions, and modifications without departing from the spirit and scope of the present disclosure.

What is claimed is:

1. An optical system comprising, in order from an object side, a first negative lens having negative refractive power, a second negative lens having negative refractive power, and a rear group,
the optical system satisfying the following conditional expressions.
$$\begin{matrix}5.6 < TL / f < 13. \\ 0.3 < f 1 / f 2 < 2. \\ 1.6 6 < Nave 12 < 2.2 \\ 80. < 2 ω\end{matrix}$$
where
TL: the total length of the optical system
f: the focal length of the optical system
f1: the focal length of the first negative lens
f2: the focal length of the second negative lens
Nave12: an average of the refractive indices of the first and second negative lenses
2ω: the total field angle of the optical system

2. An optical system comprising, in order from an object side, a first negative lens having negative refractive power, a second negative lens having negative refractive power, and a rear group,
the optical system satisfying the following conditional expressions.
$$\begin{matrix}0.41 < T 112 / f < 3.95 \\ 0.3 < ( r 31 + r 22 ) / ( r 31 - r 22 ) < 2.6 \\ 80. < 2 ω\end{matrix}$$
where
T112: the total thickness on the optical axis from an object-side lens surface of the first negative lens to an image-plane-side lens surface of the second negative lens
f: the focal length of the optical system
r22: the radius of curvature of the image-plane-side lens surface of the second negative lens
r31: the radius of curvature of an object-side lens surface of a lens disposed next to the second negative lens on the image plane side
2ω: the total field angle of the optical system

3. An optical system comprising, in order from an object side, a first negative lens having negative refractive power, a second negative lens having negative refractive power, and a rear group,
the optical system satisfying the following conditional expressions.
$$\begin{matrix}1.2 < ( - f 1 ) / f < 5.10 \\ 1.91 < ( - f 2 ) / f < 7.00 \\ 0.9 < T 112 / f < 8.00 \\ 80. < 2 ω\end{matrix}$$
where
f1: the focal length of the first negative lens
f: the focal length of the optical system
f2: the focal length of the second negative lens
T112: the total thickness on the optical axis from an object-side lens surface of the first negative lens to an image-plane-side lens surface of the second negative lens
2ω: the total field angle of the optical system

4. The optical system according to claim 1, wherein the first negative lens, the second negative lens, and all lenses included in the rear group are each configured as a single lens.

5. The optical system according to claim 1, wherein all lenses included in the rear group have positive refractive power.

6. The optical system according to claim 1, wherein the following conditional expression is satisfied.
$$0.5 < ( r 21 + r 12 ) / ( r 21 - r 12 ) < 8.00$$
where
r12: the radius of curvature of an image-plane-side lens surface of the first negative lens
r21: the radius of curvature of an object-side lens surface of the second negative lens

7. The optical system according to claim 1, wherein the following conditional expression is satisfied.
$$1. < f 3 / f < 80.00$$
where
f3: the focal length of a lens disposed closest to the object side in the rear group

8. The optical system according to claim 1, wherein the following conditional expression is satisfied.
$$- 30.00 < f 4 / f < 25.00$$
where
f4: the focal length of a lens component disposed second closest to the object side in the rear group

9. The optical system according to claim 1, wherein the rear group includes an aperture stop, and the following conditional expression is satisfied.
$$2. \text{<\textbar} f s - 1 \vert / f < 30.00$$
where
fs−1: the focal length of a lens disposed next to the aperture stop on the object side

10. The optical system according to claim 1, wherein the rear group includes an aperture stop, and the following conditional expression is satisfied.
$$3. < ( f s + 1 ) / f < 25.00$$
where
fs+1: the focal length of a lens component disposed next to the aperture stop on the image plane side

11. The optical system according to claim 1, wherein the following conditional expression is satisfied.
$$0.3 < ( - f 1 ) / fL < 2.00$$
where
f1: the focal length of the first negative lens
fL: the focal length of a lens disposed closest to the image plane side

12. The optical system according to claim 1, wherein the following conditional expression is satisfied.
$$0.8 < D 112 / f < 3.00$$
where
D112: the distance on the optical axis between an image-plane-side lens surface of the first negative lens and an object-side lens surface of the second negative lens

13. The optical system according to claim 1, wherein the following conditional expression is satisfied.
$$0.4 \text{<-} ( fn ) / fp < 1.50$$
where
fn: the combined focal length of the first and second negative lenses
fp: the focal length of the rear group

14. The optical system according to claim 1, wherein the following conditional expression is satisfied.
$$0.15 < D 112 / ( - f 1 ) < 0.80$$
where
D112: the distance on the optical axis between an image-plane-side lens surface of the first negative lens and an object-side lens surface of the second negative lens
f1: the focal length of the first negative lens

15. The optical system according to claim 1, wherein the following conditional expression is satisfied.
$$0.5 < D 112 / ( - fn ) < 1.50$$
where
D112: the distance on the optical axis between an image-plane-side lens surface of the first negative lens and an object-side lens surface of the second negative lens
fn: the combined focal length of the first and second negative lenses

16. The optical system according to claim 1, wherein the following conditional expression is satisfied.
$$1.66 < n 1 < 2.30$$
where
n1: the refractive index of the first negative lens

17. The optical system according to claim 1, wherein the following conditional expression is satisfied.
$$2.2 < fL / f < 6.00$$
where
fL: the focal length of a lens disposed closest to the image plane side

18. An optical apparatus comprising the optical system according to claim 1.

19. The optical apparatus according to claim 1, further comprising a light emitter that emits light of a wavelength in the range from visible light to near-infrared light.

20. A method for manufacturing an optical system including, in order from an object side, a first negative lens having negative refractive power, a second negative lens having negative refractive power, and a rear group,
the method comprising disposing lenses so as to satisfy the following conditional expressions.
$$\begin{matrix}5.6 < TL / f < 13.00 \\ 0.3 < f 1 / f 2 < 2. \\ 1.66 < Nave 12 < 2.20 \\ 80. < 2 ω\end{matrix}$$
where
TL: the total length of the optical system
f: the focal length of the optical system
f1: the focal length of the first negative lens
f2: the focal length of the second negative lens
Nave12: an average of the refractive indices of the first and second negative lenses
2ω: the total field angle of the optical system
